(19) United States
(12) Patent Application Publication
(10) Pub. No.: US 2021/0012791 A1
(43) Pub. Date: Jan. 14, 2021

(54) IMAGE REPRESENTATION OF A CONVERSATION TO SELF-SUPERVISED LEARNING

(71) Applicant: XBrain, Inc., Menlo Park, CA (US)

(72) Inventors: Gregory Jean-Francois Renard, Menlo Park, CA (US); Stephane Roger Dadian, Palo Alto, CA (US); Luis Matias Montero, East Palo Alto, CA (US)

(21) Appl. No.: 16/923,372

(22) Filed: Jul. 8, 2020

Related U.S. Application Data
(60) Provisional application No. 62/871,645, filed on Jul. 8, 2019.

(51) Int. Cl. G10L 21/10; G10L 21/18; G10L 15/22; G10L 15/18; G06N 3/08

(52) U.S. Cl. CPC G10L 21/10; G10L 21/18; G10L 15/22; G10L 15/063; G06N 3/08; G10L 2015/228; G10L 15/1822

(57) ABSTRACT

A system and method for receiving, using one or more processors, a first conversation; identifying, using the one or more processors, a first set of utterances associated with a first conversation participant and a second set of utterances associated with a second conversation participant; and generating, using the one or more processors, a first image representation of the first conversation, the first image representation of the first conversation visually representing the first set of utterances and second set of utterances, wherein an utterance is visually represented by a first parameter associated with timing of the utterance, a second parameter associated with a number of tokens in the utterance, and a third parameter associated with which conversation participant was a source of the utterance.

### CROSS-REFERENCE TO RELATED APPLICATIONS

The present application claims priority to U.S. Provisional Application No. 62/871,645, filed Jul. 8, 2019, titled “Conversation Graph to Self-Supervised Learning Conversations,” the entirety of which is hereby incorporated by reference.

### BACKGROUND

The field of natural language (NL) is rapidly expanding. The field of natural language has a number of issues. One issue is that NL focuses on the analysis of content, i.e., the content of utterances, sentences, paragraphs, etc. While human communication relies heavily on non-content-based cues, for example, body language, intonation, etc. The sole focus on content neglects other and important facets of human communication. Another issue is that existing dialogue systems (DS) create an ever-growing amount of data from conversations generated by those DSs, and it is increasingly difficult to keep up with and provide expert analysis of such data.

Current systems obtain a dataset of thousands of human-to-human conversations (e.g. customer to call center agent), which are processed by people who read the conversations, understanding which conversations are relevant, cluster the conversations, and for each cluster extract the relevant conversation cardinal to represent the meaning of the group of conversations, extract the conversation flow and intents from the conversations, and extract utterances to train the machine to classify the dialog intents. The process is time consuming and human-labor intensive and cannot keep up with the pace at which new data is generated for an individual system or demand for additional dialogue systems.

### SUMMARY

In general, an innovative aspect of the subject matter described in this disclosure may be embodied in methods that include receiving, using one or more processors, a first conversation; identifying, using the one or more processors, a first set of utterances associated with a first conversation participant and a second set of utterances associated with a second conversation participant; and generating, using the one or more processors, a first image representation of the first conversation, the first image representation of the first conversation visually representing the first set of utterances and second set of utterances, where an utterance is visually represented by a first parameter associated with timing of the utterance, a second parameter associated with a number of tokens in the utterance, and a third parameter associated with which conversation participant was a source of the utterance.

According to another innovative aspect of the subject matter described in this disclosure, a system that comprises a processor; and a memory storing instructions that, when executed, cause the system to: receive a first conversation; identify a first set of utterances associated with a first conversation participant and a second set of utterances associated with a second conversation participant; and generate a first image representation of the first conversation, the first image representation of the first conversation visually representing the first set of utterances and second set of utterances, wherein an utterance is visually represented by a first parameter associated with timing of the utterance, a second parameter associated with a number of tokens in the utterance, and a third parameter associated with which conversation participant was a source of the utterance.

Other implementations of one or more of these aspects include corresponding systems, apparatus, and computer programs, configured to perform the actions of the methods, encoded on computer storage devices. These and other implementations may each optionally include one or more of the following features. The method where the first image representation of the first conversation is a bar chart, the bar chart including a set of bars, each bar in the set of bars associated with an utterance from one of the first set of utterances and the second set of utterances, a location and first dimension of a first bar along a first axis serving as the first parameter and visually representing a timing of a first utterance represented by the first bar, a second dimension of the first bar along a second axis serving as the second parameter and visually representing a number of consecutive tokens in the first utterance represented by the first bar, and whether the first bar extends in a first direction or second direction from the first axis serving as the third parameter and visually representing whether the first utterance was that of the first conversation participant or the second conversation participant. The method may include: analyzing the first image representation of the first conversation; identifying, from the first image representation of the first conversation, a hold; and categorizing the first conversation into a first category based on the identification of the hold. The method may include: analyzing the first image representation of the first conversation; identifying, from the first image representation of the first conversation, a negative indicator; and categorizing the first conversation into a first category based on the identification of the negative indicator. The negative indicator is based on a ratio between a duration of an utterance and a number of tokens in the utterance, where an utterance may include a sequence of consecutive tokens. The first image representation of the first conversation is generated contemporaneously with the first conversation, and subsequent to identifying the negative indicator, the first conversation is identified for intervention. Filtering the first conversation includes adding the first conversation to a category based on detecting one or more of a conversational phase and a conversational affect in the first conversation, and where filtering the utterance within the first conversation includes one or more of identifying one or more of a negative indicator, active listening, pleasantries, information verification, and user intent. An intent is associated with an utterance that satisfies a threshold, the threshold associated with an average number of tokens per utterance. The method may include: receiving the one or more intents identified within the first conversation and one or more intents identified in one or more other conversations; clustering the one or more intents identified within the first conversation and the one or more intents identified in one or more other conversations to generate a set of clusters associated with unique intents; generating a conversation map visually representing a first cluster associated with a first unique intent as a first node, a second cluster associated with a second unique intent as a second node, and visually representing a transition between the first unique intent to the second unique intent as edges; and identifying, from the conversation map, a preferred path; and performing self-supervised learning based on the preferred path. The preferred path is one of a shortest path and a densest path It should be understood that this list of features and advantages is not all-inclusive and many additional features and advantages are contemplated and fall within the scope of the present disclosure. Moreover, it should be understood that the language used in the present disclosure has been principally selected for readability and instructional purposes, and not to limit the scope of the subject matter disclosed herein.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 is a block diagram illustrating an example system for conversation graphing according to one embodiment.

FIG. 2 is a block diagram illustrating an example computing device according to one embodiment.

FIG. 3 is a block diagram illustrating an example of a conversation analysis engine according to one embodiment.

FIG. 4 is an illustration of an example image representation of a conversation according to one embodiment.

FIGS. 5a-5f are illustrations of an example image representations of “regular” conversations according to one embodiment.

FIGS. 6a-6f are illustrations of an example image representations of conversations including a hold according to one embodiment.

FIG. 7 is an illustration of an example image representation of a conversation according to one embodiment.

FIGS. 8a-8c are illustrations of an example image representations of conversations on hold according to one embodiment.

FIGS. 9a-c are illustrations of an example image representations of conversations that are “exceptions” according to one embodiment.

FIG. 10 is an illustration of an example conversations map according to one embodiment.

FIG. 11 is an illustration of another example conversations map according to one embodiment.

FIG. 12A-12D illustrate an example report according to one embodiment.

FIG. 13 is a flowchart of an example method for conversation analysis according to some embodiments.

FIG. 14 is a flowchart of an example method for conversation analysis to identify an exception according to some embodiments.

FIG. 15 is a flowchart of an example method for image representation to self-supervised learning according to some embodiments.

### DETAILED DESCRIPTION

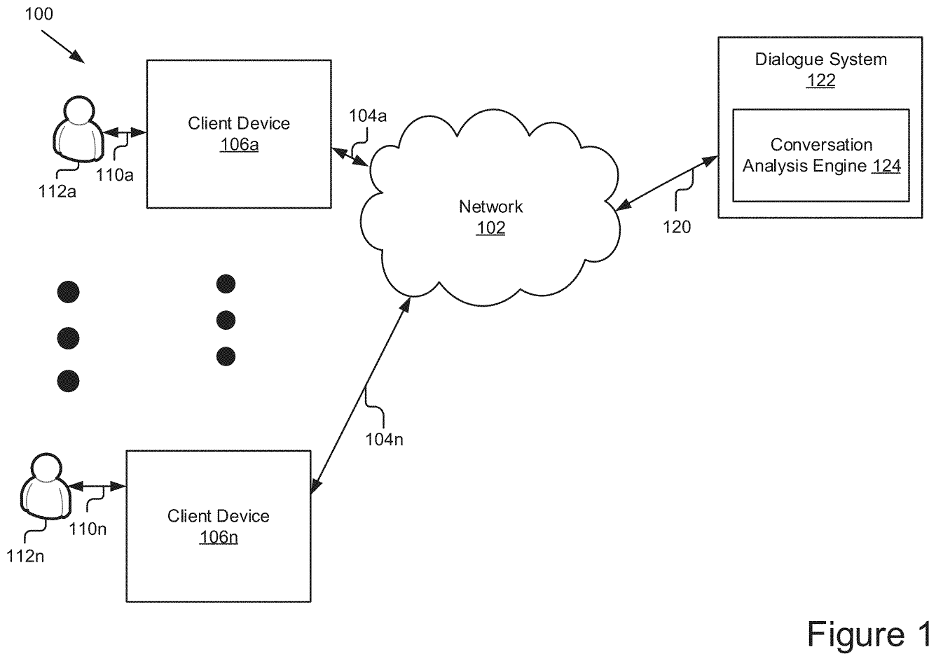

FIG. 1 is a block diagram illustrating an example system 100 for conversation graphing according to one embodiment. The illustrated system 100 includes client devices 106a . . . 106n and a dialogue system 122, which are communicatively coupled via a network 102 for interaction with one another. For example, the client devices 106a . . . 106n may be respectively coupled to the network 102 via signal lines 104a . . . 104n and may be accessed by users 112a . . . 112n (also referred to individually and collectively as user 112) as illustrated by lines 110a . . . 110n. The use of the nomenclature “a” and “n” in the reference numbers indicates that any number of those elements having that nomenclature may be included in the system 100. The dialogue system 122 may be coupled to the network 102 via signal line 120.

The network 102 may include any number of networks and/or network types. For example, the network 102 may include, but is not limited to, one or more local area networks (LANs), wide area networks (WANs) (e.g., the Internet), virtual private networks (VPNs), mobile networks (e.g., the cellular network), wireless wide area network (WWANs), Wi-Fi networks, WiMAX® networks, Bluetooth® communication networks, peer-to-peer networks, other interconnected data paths across which multiple devices may communicate, various combinations thereof, etc. Data transmitted by the network 102 may include packetized data (e.g., Internet Protocol (IP) data packets) that is routed to designated computing devices coupled to the network 102. In some implementations, the network 102 may include a combination of wired and wireless (e.g., terrestrial or satellite-based transceivers) networking software and/or hardware that interconnects the computing devices of the system 100. For example, the network 102 may include packet-switching devices that route the data packets to the various computing devices based on information included in a header of the data packets.

The data exchanged over the network 102 can be represented using technologies and/or formats including the hypertext markup language (HTML), the extensible markup language (XML), JavaScript Object Notation (JSON), Comma Separated Values (CSV), Java DataBase Connectivity (JDBC), Open DataBase Connectivity (ODBC), etc. In addition, all or some of links can be encrypted using conventional encryption technologies, for example, the secure sockets layer (SSL), Secure HTTP (HTTPS) and/or virtual private networks (VPNs) or Internet Protocol security (IPsec). In another embodiment, the entities can use custom and/or dedicated data communications technologies instead of, or in addition to, the ones described above. Depending upon the embodiment, the network 102 can also include links to other networks. Additionally, the data exchanged over network 102 may be compressed.

The client devices 106a . . . 106n (also referred to individually and collectively as client device 106) are computing devices having data processing and communication capabilities. While FIG. 1 illustrates two client devices 106, the present specification applies to any system architecture having one or more client devices 106. In some embodiments, a client device 106 may include a processor (e.g., virtual, physical, etc.), a memory, a power source, a network interface, and/or other software and/or hardware components, such as a display, graphics processor, wireless transceivers, keyboard, speakers, camera, sensors, firmware, operating systems, drivers, various physical connection interfaces (e.g., USB, HDMI, etc.). The client devices 106a . . . 106n may couple to and communicate with one another and the other entities of the system 100 via the network 102 using a wireless and/or wired connection.

Examples of client devices 106 may include, but are not limited to, automobiles, robots, mobile phones (e.g., feature phones, smart phones, etc.), tablets, laptops, desktops, netbooks, server appliances, servers, virtual machines, TVs, set-top boxes, media streaming devices, portable media players, navigation devices, personal digital assistants, etc. While two or more client devices 106 are depicted in FIG. 1, the system 100 may include any number of client devices 106. In addition, the client devices 106a . . . 106n may be the same or different types of computing devices. For example, in one embodiment, the client device 106a is an automobile and client device 106n is a mobile phone.

In the depicted implementation, the dialogue system 122 includes an instance of the conversation analysis engine 124. The dialogue system 122 may include one or more computing devices having data processing, storing, and communication capabilities. For example, the dialogue system 122 may include one or more hardware servers, server arrays, storage devices, systems, etc., and/or may be centralized or distributed/cloud-based. In some implementations, the dialogue system 122 may include one or more virtual servers, which operate in a host server environment and access the physical hardware of the host server including, for example, a processor, memory, storage, network interfaces, etc., via an abstraction layer (e.g., a virtual machine manager). The dialogue system 122 receives or conducts dialogues, which may include verbal/speech-based dialogues (e.g. phone calls) and/or written/text-based dialogues (e.g. instant messenger or chatbot exchanges) depending on the embodiment.

It should be understood that the system 100 illustrated in FIG. 1 is representative of an example system according to one embodiment and that a variety of different system environments and configurations are contemplated and are within the scope of the present disclosure. For instance, various functionality may be moved from a server to a client, or vice versa and some implementations may include additional or fewer computing devices, servers, and/or networks, and may implement various functionality client or server-side. Further, various entities of the system 100 may be integrated into to a single computing device or system or divided among additional computing devices or systems, etc.

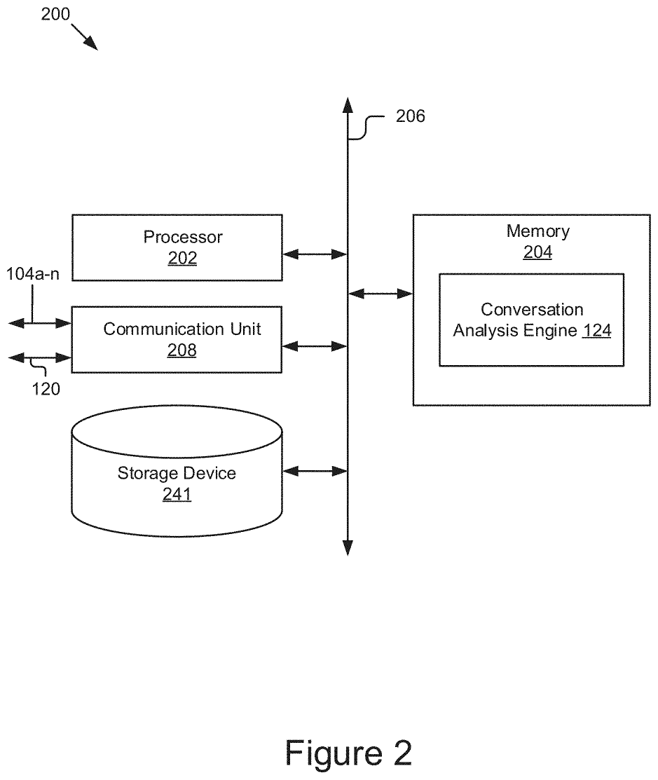

FIG. 2 is a block diagram of an example computing device 200 according to one embodiment. The computing device 200, as illustrated, may include a processor 202, a memory 204, a communication unit 208, and a storage device 241, which may be communicatively coupled by a communications bus 206. The computing device 200 depicted in FIG. 2 is provided by way of example and it should be understood that it may take other forms and include additional or fewer components without departing from the scope of the present disclosure. For example, while not shown, the computing device 200 may include input and output devices (e.g., a display, a keyboard, a mouse, touch screen, speakers, etc.), various operating systems, sensors, additional processors, and other physical configurations. Additionally, it should be understood that the computer architecture depicted in FIG. 2 and described herein can be applied to multiple entities in the system 100 with various modifications, including, for example, a client device 106 (e.g. by omitting the conversation analysis engine 124) and a dialogue system 122 (e.g. by including the conversation analysis engine 124, as illustrated).

The processor 202 comprises an arithmetic logic unit, a microprocessor, a general purpose controller, a field programmable gate array (FPGA), an application specific integrated circuit (ASIC), or some other processor array, or some combination thereof to execute software instructions by performing various input, logical, and/or mathematical operations to provide the features and functionality described herein. The processor 202 may execute code, routines and software instructions by performing various input/output, logical, and/or mathematical operations. The processor 202 have various computing architectures to process data signals including, for example, a complex instruction set computer (CISC) architecture, a reduced instruction set computer (RISC) architecture, and/or an architecture implementing a combination of instruction sets. The processor 202 may be physical and/or virtual, and may include a single core or plurality of processing units and/or cores. In some implementations, the processor 202 may be coupled to the memory 204 via the bus 206 to access data and instructions therefrom and store data therein. The bus 206 may couple the processor 202 to the other components of the computing device 200 including, for example, the memory 204, communication unit 208, and the storage device 241.

The memory 204 may store and provide access to data to the other components of the computing device 200. In some implementations, the memory 204 may store instructions and/or data that may be executed by the processor 202. For example, as depicted, the memory 204 may store one or more engines including the conversation analysis engine 124. The memory 204 is also capable of storing other instructions and data, including, for example, an operating system, hardware drivers, software applications, databases, etc. The memory 204 may be coupled to the bus 206 for communication with the processor 202 and the other components of the computing device 200.

The memory 204 includes a non-transitory computer-usable (e.g., readable, writeable, etc.) medium, which can be any apparatus or device that can contain, store, communicate, propagate or transport instructions, data, computer programs, software, code, routines, etc., for processing by or in connection with the processor 202. In some implementations, the memory 204 may include one or more of volatile memory and non-volatile memory. For example, the memory 204 may include, but is not limited, to one or more of a dynamic random access memory (DRAM) device, a static random access memory (SRAM) device, a discrete memory device (e.g., a PROM, FPROM, ROM), a hard disk drive, an optical disk drive (CD, DVD, Blue-ray™, etc.). It should be understood that the memory 204 may be a single device or may include multiple types of devices and configurations.

The bus 206 can include a communication bus for transferring data between components of the computing device or between computing devices 106/122, a network bus system including the network 102 or portions thereof, a processor mesh, a combination thereof, etc. In some implementations, the conversation analysis engine 124, its sub-components and various software operating on the computing device 200 (e.g., an operating system, device drivers, etc.) may cooperate and communicate via a software communication mechanism implemented in association with the bus 206. The software communication mechanism can include and/or facilitate, for example, inter-process communication, local function or procedure calls, remote procedure calls, an object broker (e.g., CORBA), direct socket communication (e.g., TCP/IP sockets) among software modules, UDP broadcasts and receipts, HTTP connections, etc. Further, any or all of the communication could be secure (e.g., SSL, HTTPS, etc.).

The communication unit 208 may include one or more interface devices (I/F) for wired and/or wireless connectivity with the network 102. For instance, the communication unit 208 may include, but is not limited to, CAT-type interfaces; wireless transceivers for sending and receiving signals using radio transceivers (4G, 3G, 2G, etc.) for communication with the mobile network 103, and radio transceivers for Wi-Fi™ and close-proximity (e.g., Bluetooth®, NFC, etc.) connectivity, etc.; USB interfaces; various combinations thereof; etc. In some implementations, the communication unit 208 can link the processor 202 to the network 102, which may in turn be coupled to other processing systems. The communication unit 208 can provide other connections to the network 102 and to other entities of the system 100 using various standard network communication protocols, including, for example, those discussed elsewhere herein.

The storage device 241 is an information source for storing and providing access to data. In some implementations, the storage device 241 may be coupled to the components 202, 204, and 208 of the computing device 200 via the bus 206 to receive and provide access to data. The data stored by the storage device 241 may vary based on the computing device 200 and the embodiment. For example, in one embodiment, the storage device 241 of a dialogue system 122 stores conversations. The conversations may include one or more human-to-human conversations, one or more human-to-machine conversations, one or more machine-to-machine conversations or a combination thereof. The conversations may be textual (e.g. chat, e-mail, SMS text, etc.) or audio (e.g. voice) or a combination thereof.

The storage device 241 may be included in the computing device 200 and/or a storage system distinct from but coupled to or accessible by the computing device 200. The storage device 241 can include one or more non-transitory computer-readable mediums for storing the data. In some implementations, the storage device 241 may be incorporated with the memory 204 or may be distinct therefrom. In some implementations, the storage device 241 may include a database management system (DBMS) operable on the dialogue system 122. For example, the DBMS could include a structured query language (SQL) DBMS, a NoSQL DMBS, various combinations thereof, etc. In some instances, the DBMS may store data in multi-dimensional tables comprised of rows and columns, and manipulate, i.e., insert, query, update and/or delete, rows of data using programmatic operations.

As mentioned above, the computing device 200 may include other and/or fewer components. Examples of other components may include a display, an input device, a sensor, etc. (not shown). In one embodiment, the computing device includes a display. The display may include any conventional display device, monitor or screen, including, for example, an organic light-emitting diode (OLED) display, a liquid crystal display (LCD), etc. In some implementations, the display may be a touch-screen display capable of receiving input from a stylus, one or more fingers of a user 112, etc. For example, the display may be a capacitive touch-screen display capable of detecting and interpreting multiple points of contact with the display surface.

The input device (not shown) may include any device for inputting information into the dialogue system 122. In some implementations, the input device may include one or more peripheral devices. For example, the input device may include a keyboard (e.g., a QWERTY keyboard or keyboard in any other language), a pointing device (e.g., a mouse or touchpad), microphone, an image/video capture device (e.g., camera), etc. In one embodiment, the computing device 200 may represent a client device 106 and the client device 106 includes a microphone for receiving voice input and speakers for facilitating text-to-speech (TTS). In some implementations, the input device may include a touch-screen display capable of receiving input from the one or more fingers of the user 112. For example, the user 112 could interact with an emulated (i.e., virtual or soft) keyboard displayed on the touch-screen display by using fingers to contacting the display in the keyboard regions.

### Example Conversation Analysis Engine 124

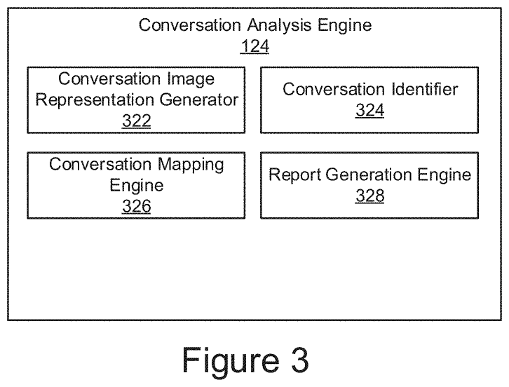

Referring now to FIG. 3, a block diagram of an example conversation analysis engine 124 is illustrated according to one embodiment. In the illustrated embodiment, the conversation analysis engine 124 includes a conversation image representation generator 322, a conversation identifier 324, a conversation mapping engine 326, and a report generation engine 328.

The conversation image representation generator 322 includes code and routines for generating an image representation of a sequence of consecutive terms. In one embodiment, the conversation image representation generator 322 is a set of instructions executable by the processor 202. In another embodiment, the conversation image representation generator 322 is stored in the memory 204 and is accessible and executable by the processor 202. In either embodiment, the conversation image representation generator 322 is adapted for cooperation and communication with the processor 202 and other components of the system 100.

The conversation image representation generator 322 receives conversations from the dialogue system 122. The conversations received may include human-to-human conversations (e.g., between a human customer and a human customer service agent), human-to-computer conversations (e.g. between a human and a digital assistant, such as Siri, Cortana, Google Assistant, etc. or between a human and a chat bot, etc.), computer-to-computer conversations (e.g. between a digital assistant and a chatbot, etc.), or a combination thereof.

In some implementations the type of conversations received may vary over time. For example, human-to-human conversations may be received and analyzed by the conversation analysis engine 124 initially, and, at a later time, human-to-computer conversations are received and analyzed by the conversation analysis engine 124, for example, to determine how well the computer-base system is emulating its human counterpart in conversation and/or to improve the computer-based system's performance in that regard or by other metrics. In some implementations, the conversation types received may remain consistent over time.

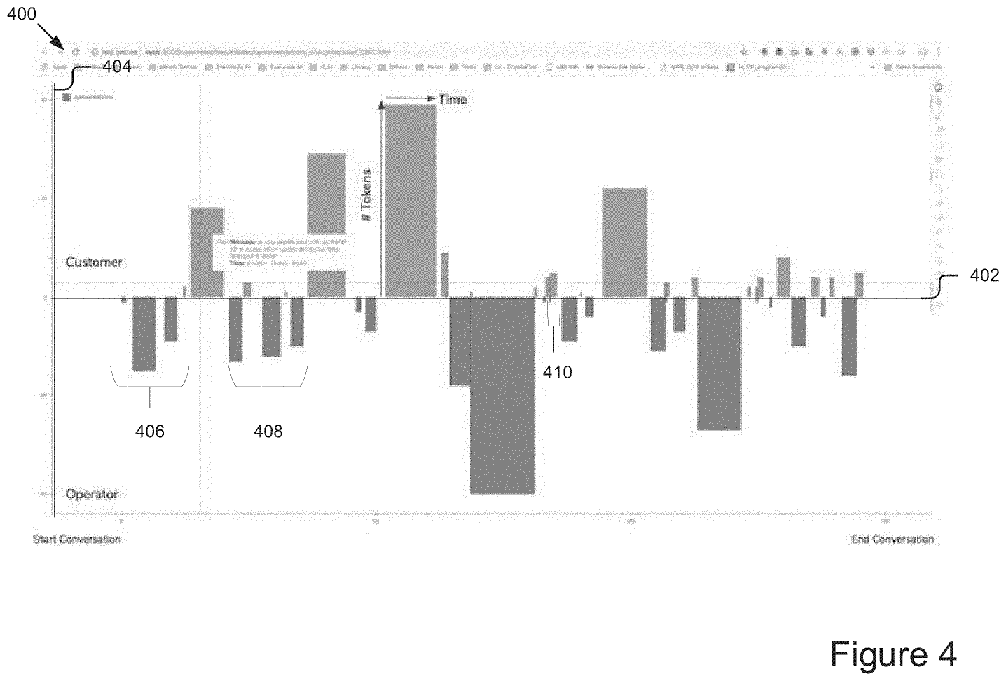

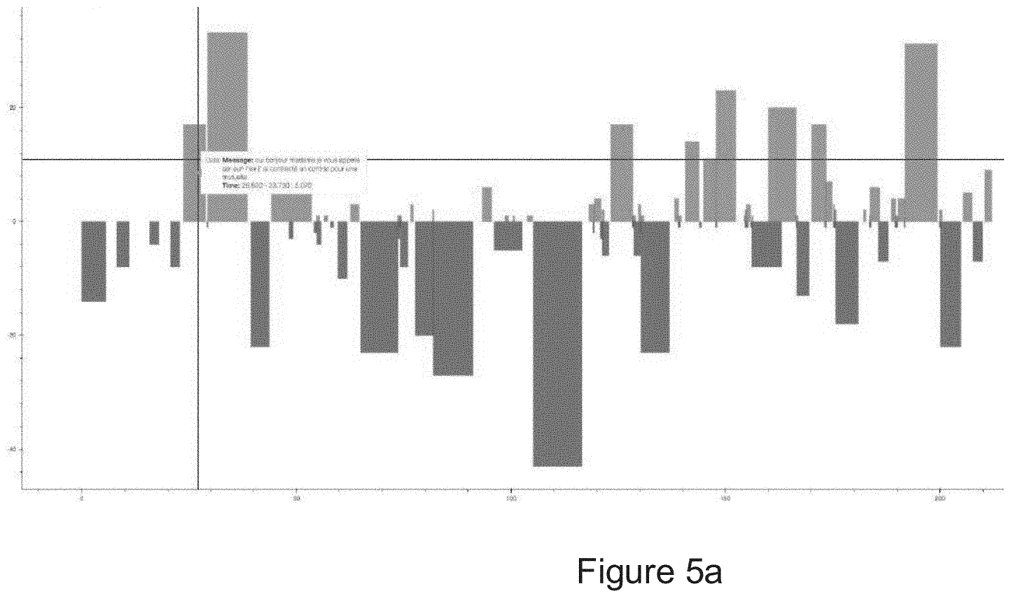

The conversation image representation generator 322 generates an image representation of a sequence of consecutive terms. In the one embodiment, the image representation uses a first parameter set to represent time, and a second parameter set to represent a number of tokens, and a third parameter set representing a source of the sequence of terms (e.g. the user). In one such embodiment, the first parameter set is represented along a first axis and the second parameter set is represented along a second axis. For example, referring to FIG. 4, time (i.e. a first parameter set) is associated with a horizontal axis 402 and a quantity of tokens (i.e. a second parameter set) is associated with a vertical axis 404, and user (i.e. a second parameter set) is associated with whether the bar extends above or below the horizontal axis 402 to indicate the number of tokens. Depending on the embodiment, a token may refer to a number of syllables, a number of letters, a number of words, a number of sentences, a number of a particular part of speech, a number of clauses, a number of a particular type of punctuation, etc.

For clarity and convenience, generation of the image representation of the sequence of terms by the conversation image representation generator 322 is discussed herein with reference to the example image representation of the conversation 400 of FIG. 4 and others having a bar chart like visualization. However, it should be recognized that the conversation (e.g. whether the conversation is human-to-human, the conversations duration, the exchanges within the conversation) will vary from conversation-to-conversation.

Further, it should be recognized that the exact features of the image layout are merely one example selected for illustrative purposes and that other conversations and image layouts are within the scope of this disclosure. In other words, while the example image representation 400 of FIG. 4 is a bar chart wherein the first axis (horizontal) is associated with time, and the second axis (vertical) is associated with tokens, it should be recognized that other image representations of a sequence of consecutive terms is contemplated and within the scope of this disclosure. For example, a linear graph, an image, or a QR Code may be used instead of a bar chart. The first parameter set and second parameter set may include other or different information than time and tokens, respectively, and the parameter sets may be represented differently than bar width and bar height, for example, either may be represented by position in an image, using line thickness, color, intensity, saturation, contrast, etc., without departing from the disclosure herein.

The conversation image representation generator 322 represents sequences of consecutive terms, also referred to as an utterance, from a conversation in the image representation. In one embodiment, the conversation image representation generator 322 visually distinguishes sequences of terms received from different users using a third parameter set. For example, referring to FIG. 4, the sequences of terms uttered (whether verbally or textually) by a customer (i.e. a first user) are visually represented by bars on one side of a time axis 402 (above, in the illustrated embodiment), and the sequences of terms uttered (whether verbally or textually) by an operator (i.e. a second user, human in this example) are visually represented by bars on the other side of the time axis 402 (below, in the illustrated environment). The first parameter set being horizontal position and width along a horizontal access (timing and duration of utterance), the second parameter set being vertical height (number of tokens in the utterance), and the third parameter set being the sign (positive or negative) determining to which side the bar extends vertically and a color or pattern identifying which user made the utterance.

The conversation image representation generator 322 represents sequences of consecutive terms from a conversation in the image representation in the temporal sequence in which they occurred. For example, referring to FIG. 4, moving from left-to-right, the bars associated with the utterances from the beginning to the end of the conversation are plotted in temporal sequence. In another example, the image could include as series of elements arranged in series (e.g. top-to-bottom and left-to-right) sequentially representing the conversation. For example, each element may be a pixel (or group of pixels) that represent a time period of the conversation, a first color (e.g. red) may represent a first user, a second color (e.g. blue) may represent a second user, and third color (e.g. green) may represent a third user, the intensities of each color in each pixel (or group thereof) representing the number of tokens the associated user uttered in that time period.

In one embodiment, the conversation image representation generator 322 uses a common time scale for utterances by different users. For example, referring to FIG. 4, where two bars associated with the two users/conversation participants overlap on the horizontal time axis 402, both users were speaking simultaneously in the conversation for the time period of the overlap, and where such an overlap of a bar does not occur, a single user was speaking (verbally or textually). In one embodiment, the conversation image representation generator 322 plots time between utterances. For example, referring to FIG. 4, the space between the bars associated with user utterances is plotted and time periods where there is no bar from either user is a pause in the conversation.

In one embodiment, the conversation image representation generator 322 represents each utterance using a first dimension associated with a number of tokens and a second dimension associated with a duration of the utterance. For example, referring to FIG. 4, a wide bar was an utterance that occurred over a longer period of time and a narrow bar is an utterance that occurred over a relatively shorter period of time, a tall bar represents an utterance with a greater number of tokens than a short bar according to the illustrated embodiment. It should be recognized that while the dimensions in the illustrated example are spatial dimensions (height and width), other dimensions (e.g. color, intensity, luminosity, etc.) are within the scope of this disclosure.

In some embodiments, for conversations where a user is a machine, which may answer near-instantaneously (particularly when responding in text), time is not represented the same as a human utterance, and a time shift is added to a machine utterance. For example, in one embodiment where the image representation is a bar chart, the start and end of a block are determined:

For a human as: [Σ_{j<i} Shiftⱼ+tᵢ−c×kᵢ,tᵢ+Σ_{j<i} Shiftⱼ]

For a machine: [Σ_{j<i} Shiftⱼ+tᵢ,tᵢ+c×kᵢ+Σ_{j<i} Shiftⱼ]

Where tᵢ the time at which the message i is received (with messages sorted by chronological order), Shiftⱼ=1_{{loc}_{ⱼ}_{=bot}}×c×kⱼ, where 1 is the indicator function. c is the average writing/speaking time per word (in seconds) for a human, and kⱼ is the number of words/tokens of the sentence/utterance j, and the expression yields is the [start, end] time.

In one embodiment, the time shift is applied post-conversation, a side effect of applying a time shift to the image representation is that the duration of the conversation represented and the actual duration of the conversation may not match. In one embodiment, the time shift for the machine is calculated and applied to a machine utterance during the conversation, which may more closely simulate having a conversation with another human (e.g. by adding a wait time to the machine's answer).

The conversation identifier 324 identifies a conversation or features within a conversation based on the image representation of the conversation.

In one embodiment, the conversation identifier 324 identifies a conversation category, occasionally also referred to as a classification, based on the image representation of the conversation. For example, the conversation identifier 324 identifies a pattern associated with the image representation and categorizes the conversation based on that pattern. The categories may vary based on the embodiment and may include, by way of example and not limitation, one or more categories regarding conversation phase presence, one or more categories regarding conversational affect, and a combination thereof.

In one embodiment, the categories used by the conversation identifier 324 include one or more categories based on conversation phase presence. The conversational phases may vary based on embodiment, but may include, by way of example and not limitation, the presence of a “hold.” In one embodiment, the conversation identifier 324 determines whether the conversation includes a hold. For example, the conversation identifier 324 identifies that one or more of (1) the conversation has no, or few, utterances indicative of the conversation being a call on hold, (2) there are extended periods without utterances indicating a hold during the conversation, and (3) repeated utterances by one user and few or no utterances by another user, which may indicate a recorded message being repeated during a hold (e.g. a message such as “Thank you for holding. Your call is important to us. Please remain on the line and a representative will be with you shortly.”) and categorizes the conversation as “hold-conversation-hold” or “on hold” as appropriate. In another example, the conversation identifier 324 determines whether the call is normal (e.g. includes utterances from both users taking turns, thereby indicating a “normal” conversation) and/or lacks signs of a hold and categorizes the conversation as “regular conversation.”

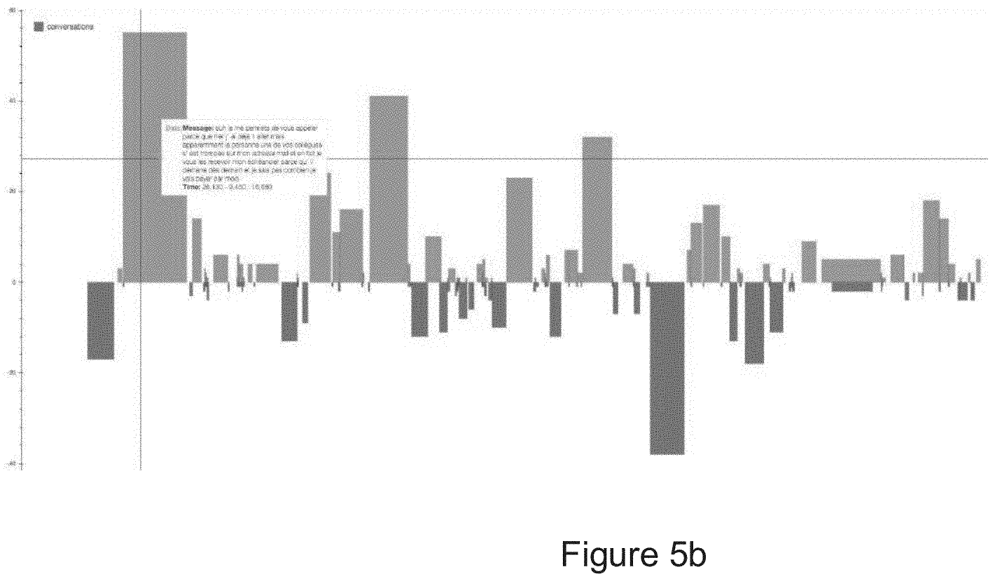

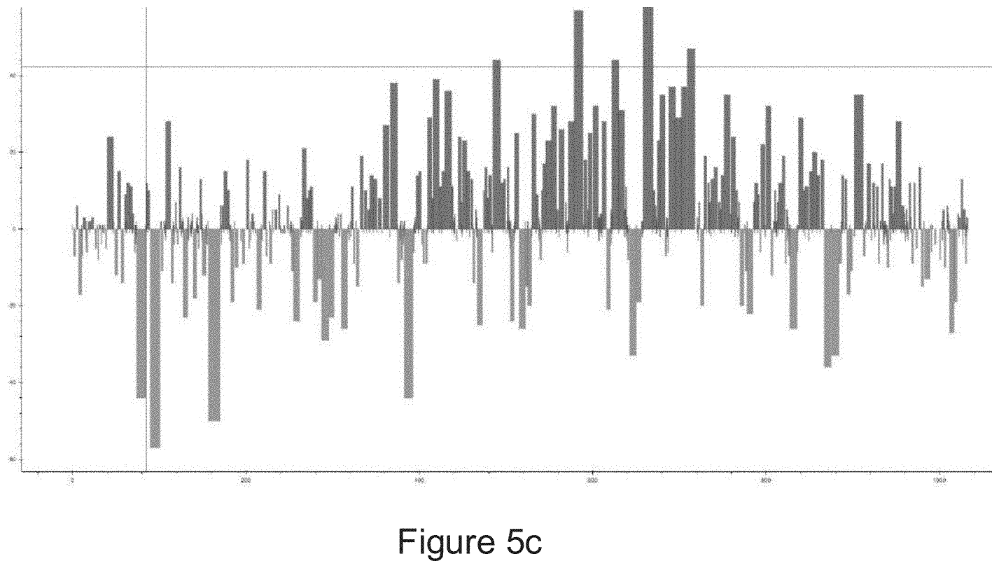

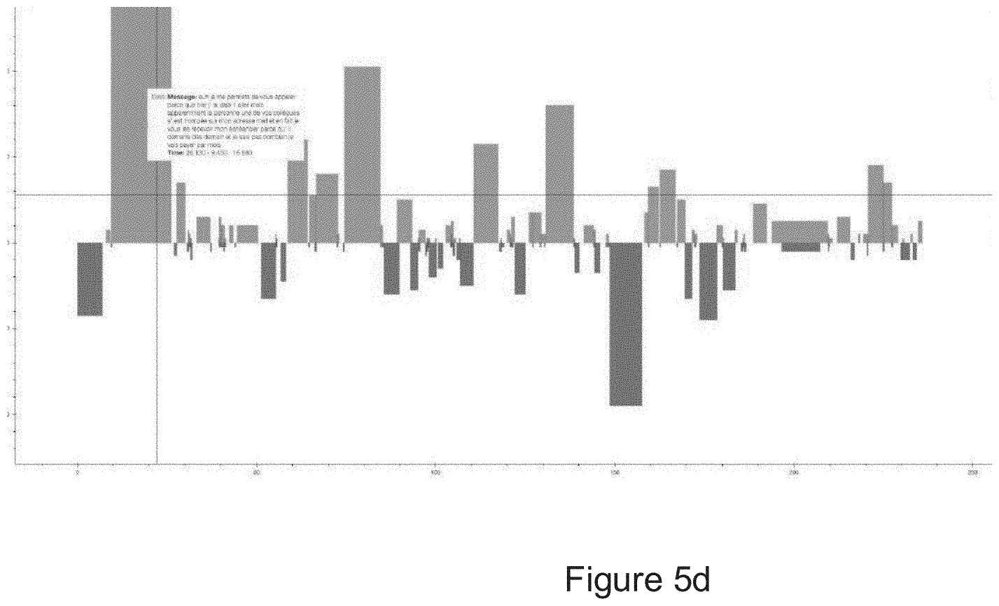

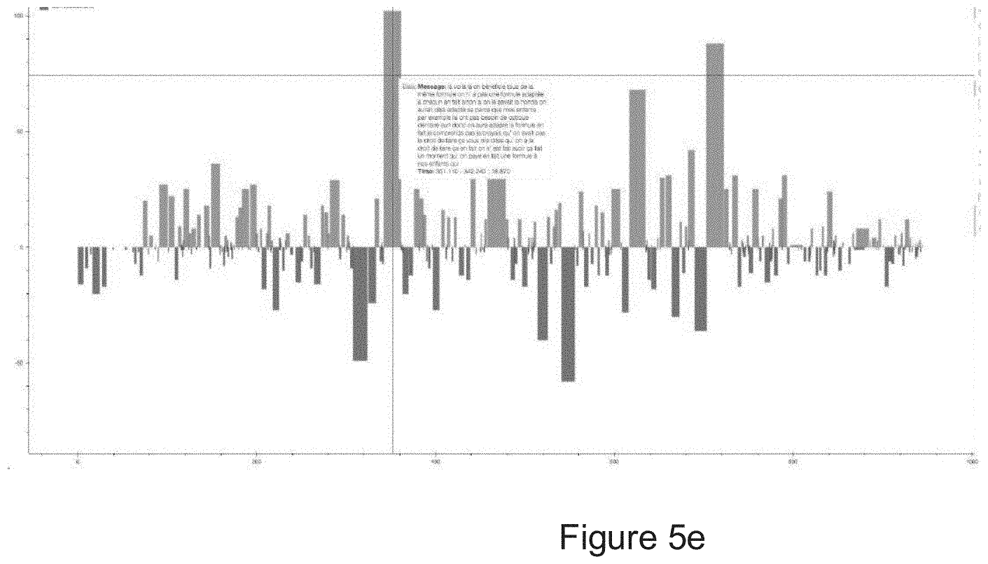

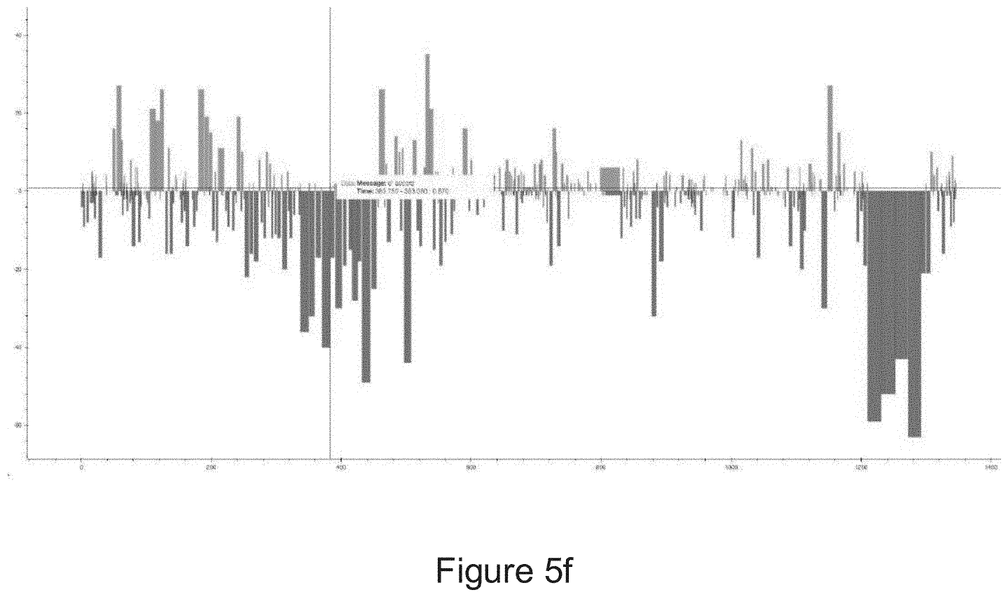

Referring to FIGS. 5a-5f, example image representations of “regular conversations” are illustrated according to one embodiment. By reviewing FIGS. 5a-5f it is apparent that images represent what is expected of a “regular conversation.” Both users take turns speaking and there are no extended silences by one party.

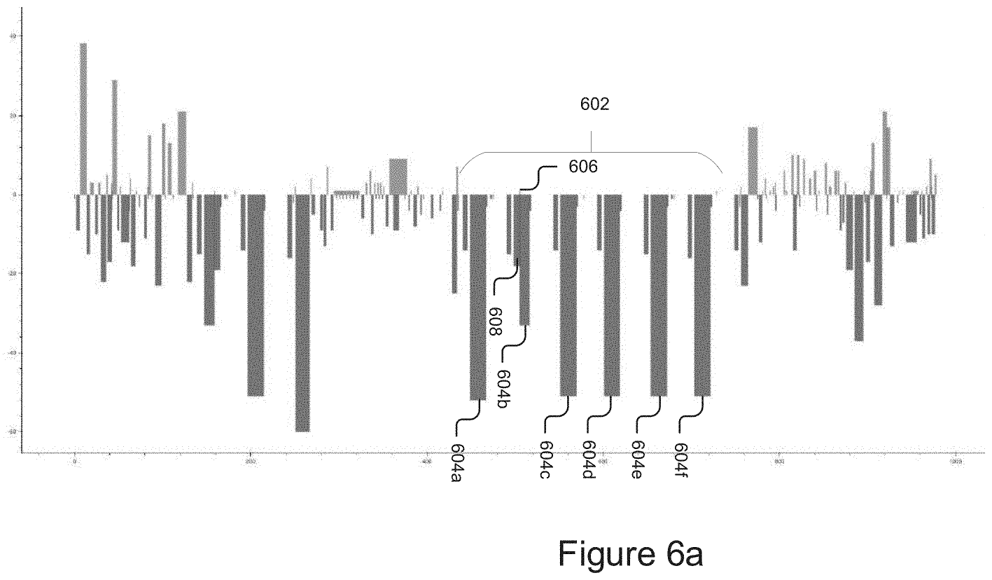

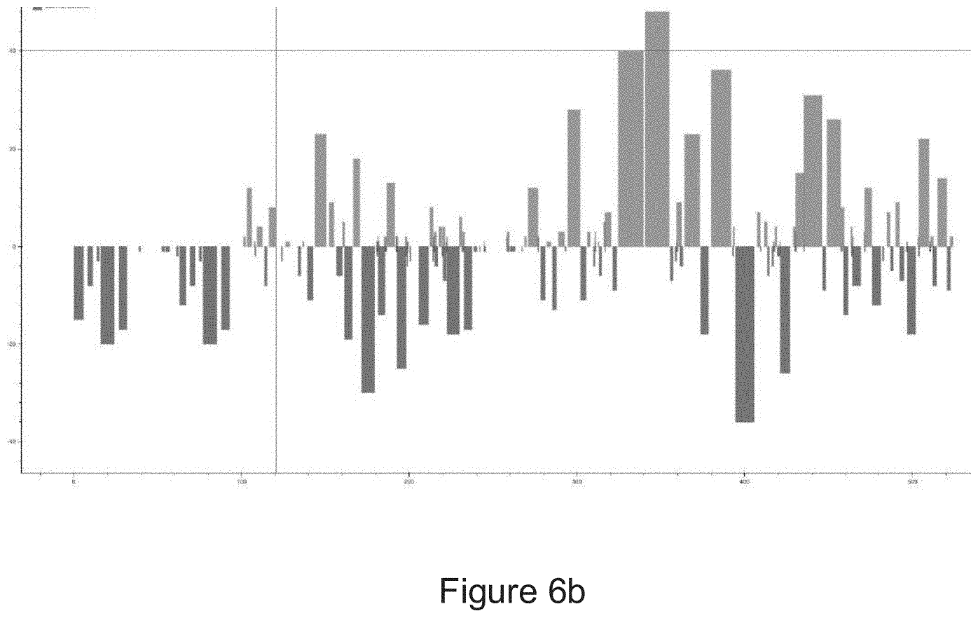

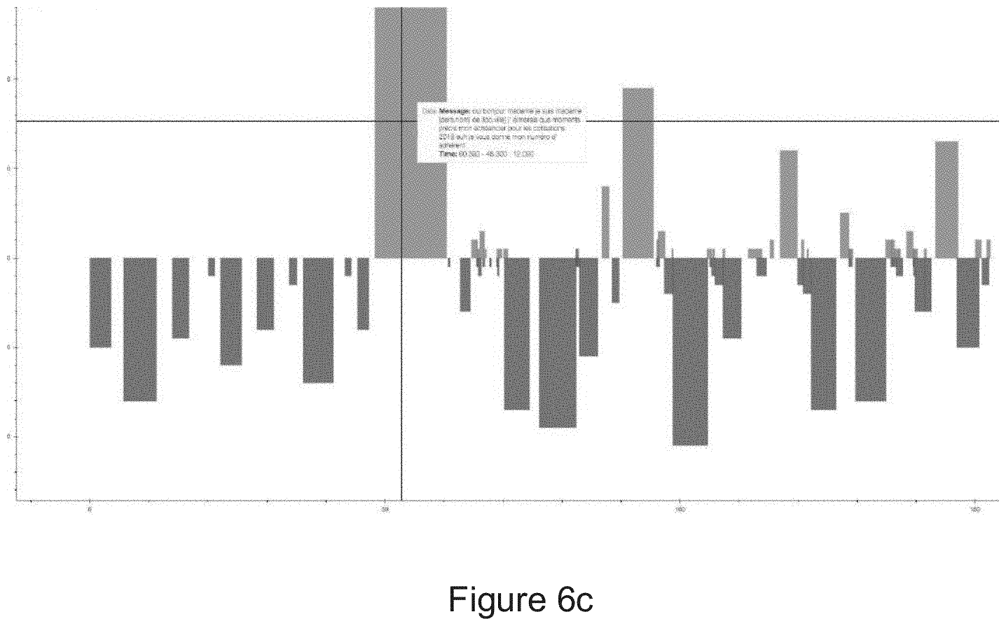

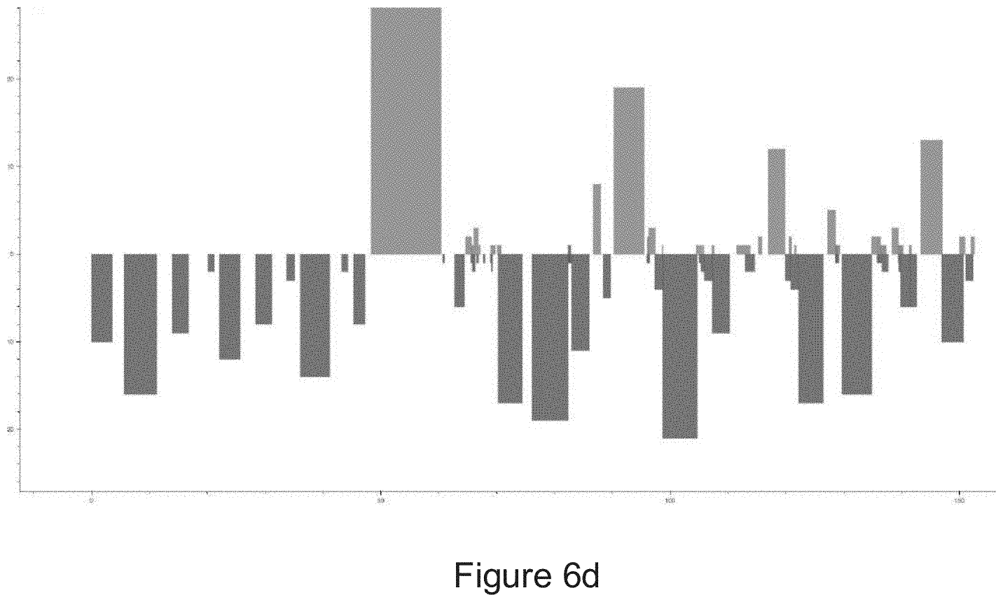

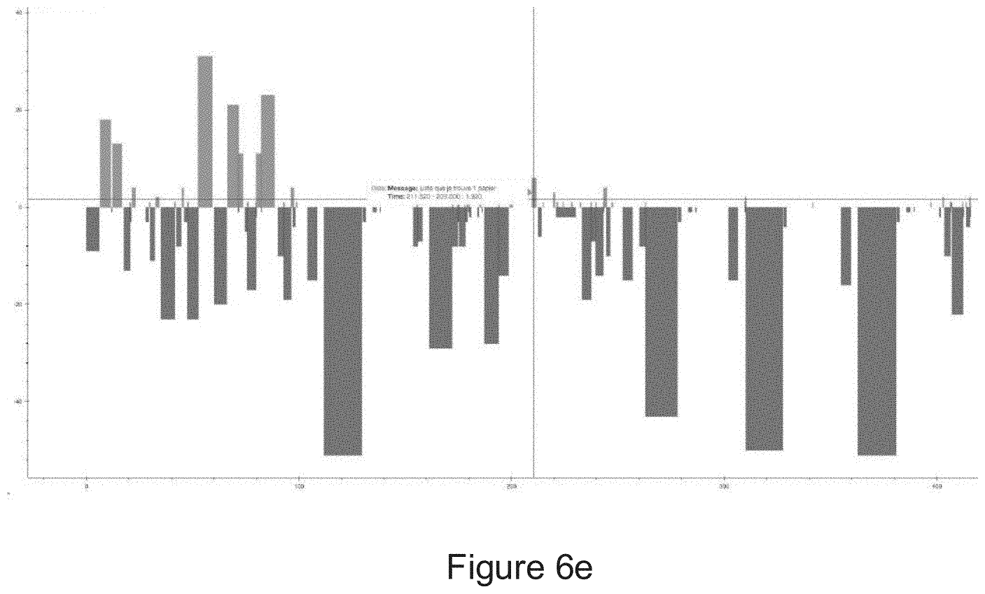

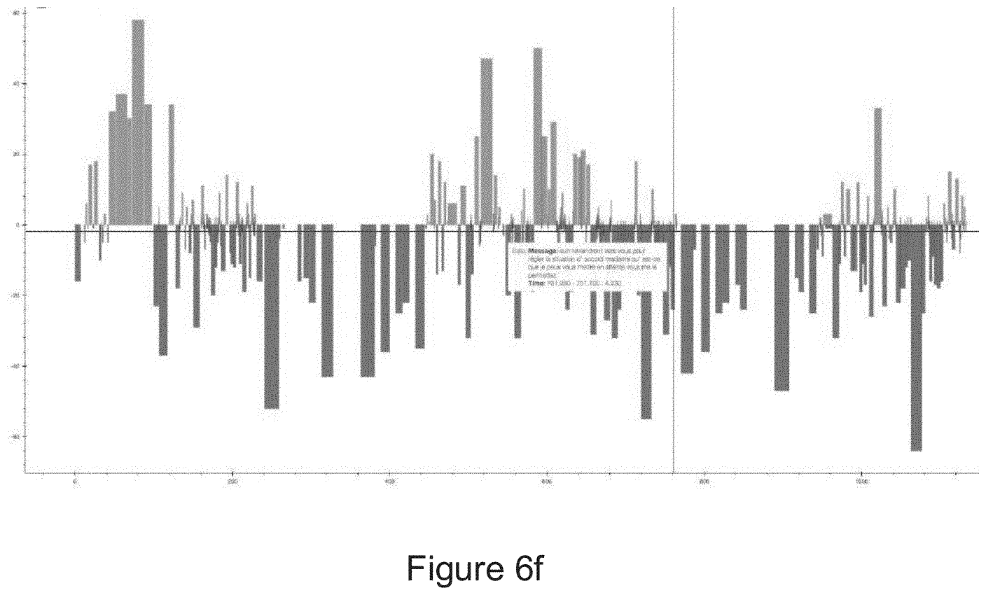

By contrast, referring to FIGS. 6a-6f, which are example image representations of conversations including a hold, and there are extended periods of unilateral or bi-lateral silence. For example, referring to FIG. 6a, it is apparent that portion 602 represents a period where the conversation is on hold. The utterances by the lower user in portion 602 are represented, in part, by the bars at 604a-f. Those utterances are likely a prerecorded message, such as “Thank you for holding. Your call is important to us. Please remain on the line and a representative will be with you shortly,” which plays at a predefined interval while the call is on hold. There is little in the way of utterances from the top user—a unilateral silence. The instance 604b varying in representation, as illustrated, from instances 604a and c-f because of the other user's utterance (e.g. a sigh) at 606, which caused the shorter bar representation at 604b and an additional (when compared to the other instances) bar 608. FIGS. 6b-6d illustrate calls with holds at the beginning of the call. Bilateral silence or unilateral silence where there is repetition of a pattern (e.g. repeating bar structure) are indicative of a hold in some embodiments.

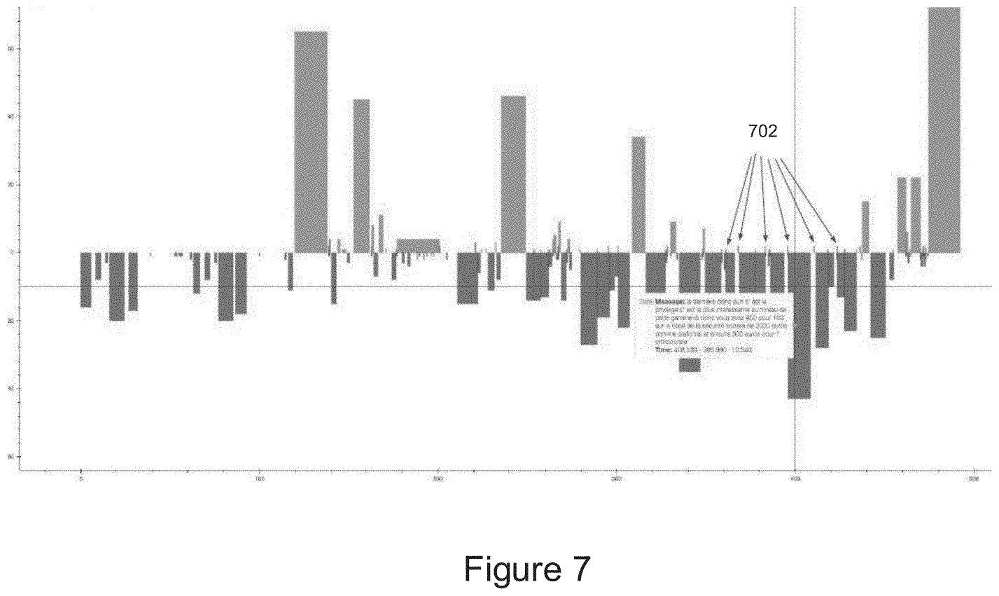

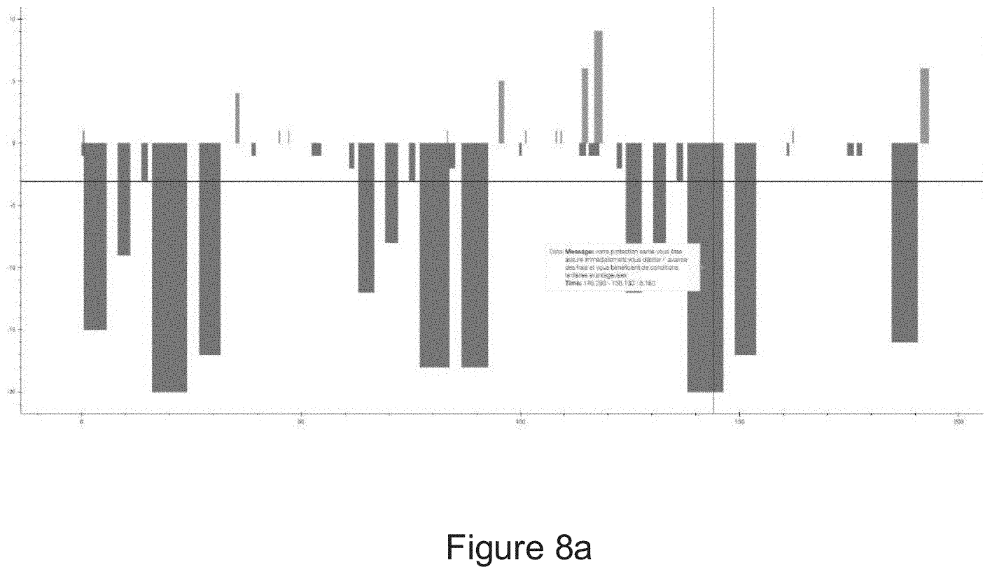

However, as indicated with above discussion, with reference to FIG. 6A, an utterance by the user on hold e.g. that at 606, may modify the representation of the other user's utterances (e.g. resulting in bars 604b and 608 rather than a bar similar to 604a). This can complicate identification of a hold period where a user occasionally makes an utterance from a period where a user is speaking at length and the other user, referring to FIG. 7, is actively listening and making an occasional utterance as represented by 702. However, as discussed below, in some embodiments, the active listening may be identified and a determination as to whether an on-hold pattern is re-established may be made.

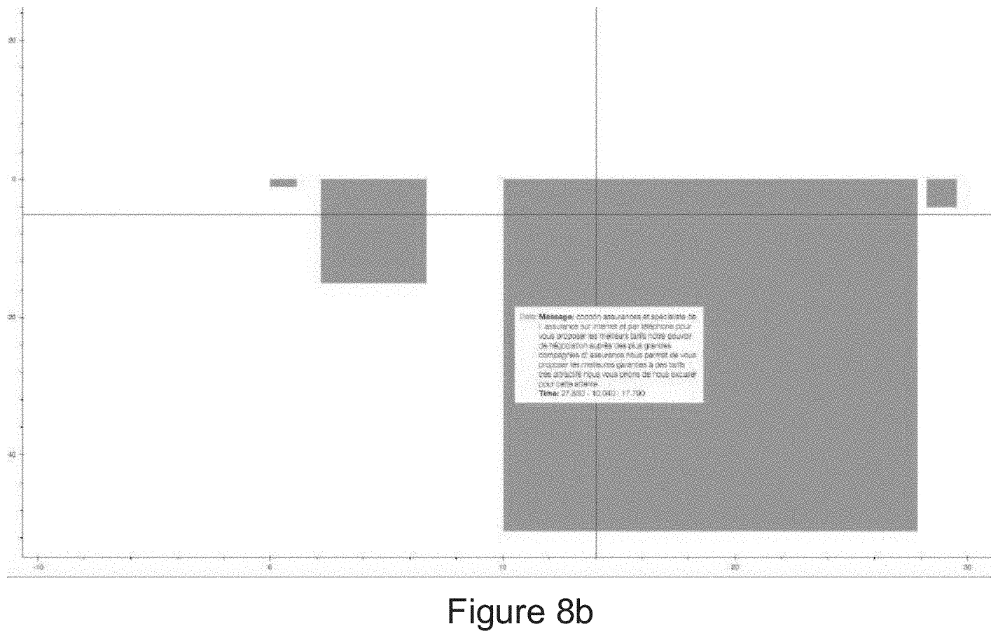

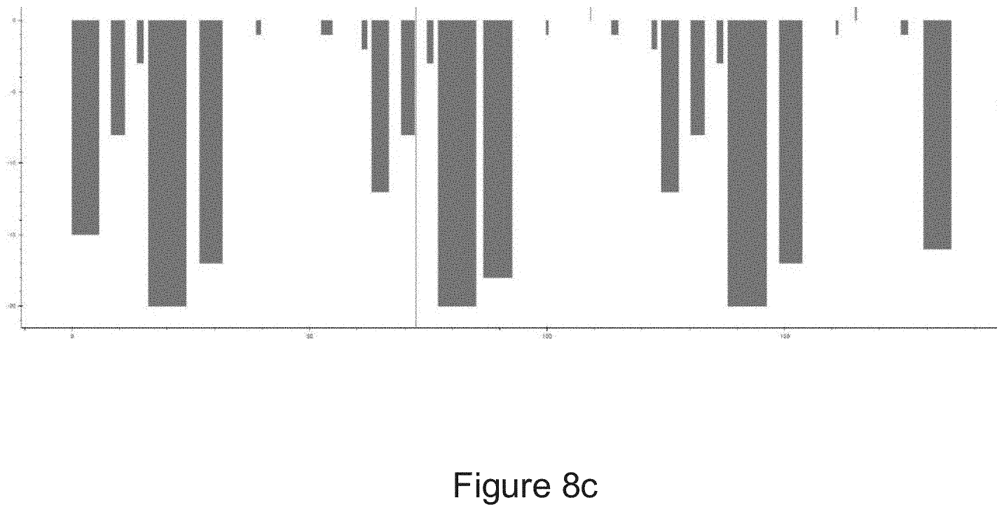

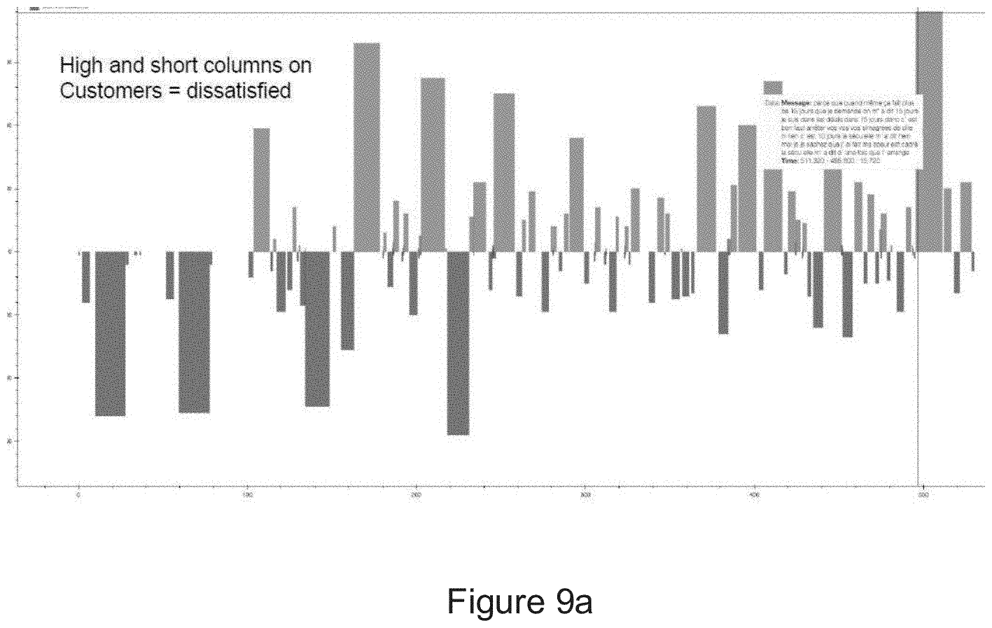

FIGS. 8a-8c are illustrations of an example image representations of conversations on hold according to one embodiment. The conversations include little to utterances from the user associated with the upper bars of the image representation.

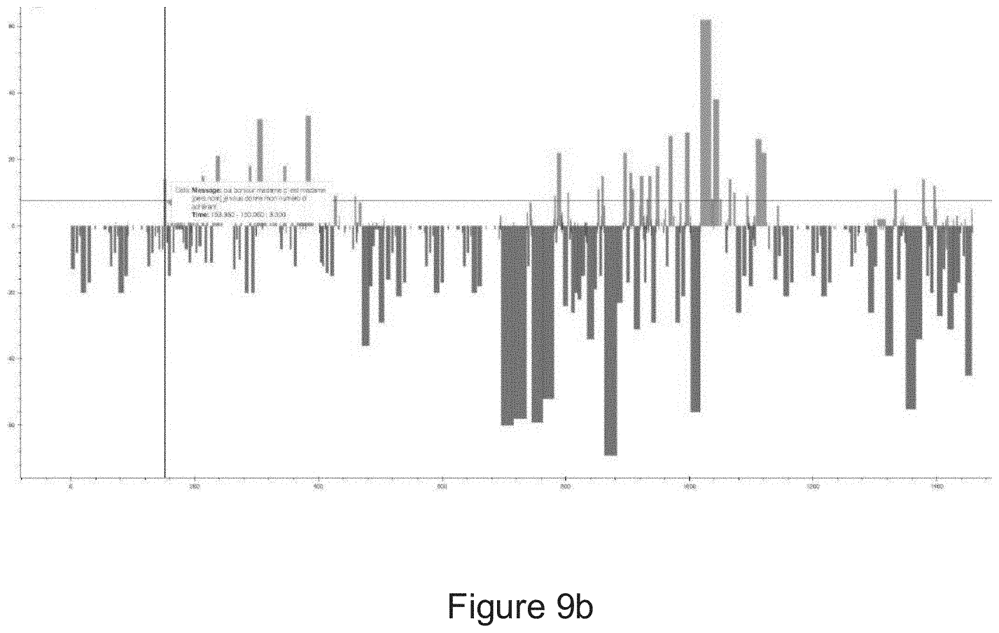

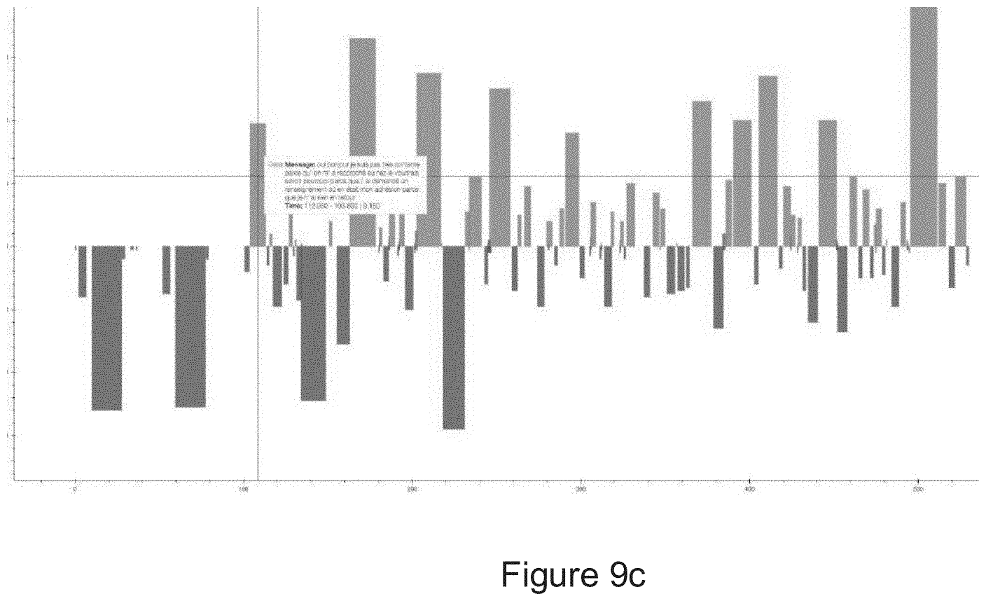

FIGS. 9a-c are illustrations of an example image representations of conversations that are “exceptions” according to one embodiment, and the bars associated with the user on the upper portion of the horizontal axis are relatively tall and narrow.

Categorization of the conversations based on conversational phase presence by the conversational identifier 324 may beneficially identify high-quality conversations to use for subsequent machine learning and those that are noisy (at least those that are not without additional processing). For example, in one embodiment, the conversations classified as “regular conversation” may be further analyzed and used to train machines (e.g. using content-based machine learning to create a chatbot), and those conversations including a hold may, depending on the embodiment, may be ignored or further processed. When conversations with a hold are further processed the hold may be remove or ignore to effectively create a conversation similar to a “regular conversation” and/or may be flagged or otherwise identified (e.g. for content-based processing to determine whether the hold is indicative of a new conversation). For example, a hold may be because a separate conversation is needed, such as may be the case if the call is transferred after an inquiry regarding recent transactions to then dispute a suspicious transaction.

It should be understood that the generation of the image representation and the categorization based on conversational phase is highly efficient compared to alternatives. Because the method does not rely on understanding the content of the conversation or and does not require review of the conversation itself at the time of categorization, the method is easy to implement and efficient (fast and using low system resources). A human or a machine may quickly and easily be trained to quickly and accurately identify “regular conversations,” “on hold calls,” and conversations with a hold before or after, i.e., “hold-conversation-hold” regardless of the ability to understand the language and/or content of what was being said in the conversation.

In one embodiment, the categories used by the conversation identifier 324 include one or more categories based on conversational affect. The categories of conversational affect may vary depending on the embodiment. In one embodiment, conversations with a negative affect (e.g. ones in which a user is aggressive, frustrated, or angry) are identified by the conversation identifier 324 and categorized/classified as “exceptions.”

In one embodiment, conversation identifier 324 identifies a conversation affect category based on a token-to-time ratio. In one embodiment, the conversation identifier 324 determines a token to time ratio of an utterance (e.g. a ratio of the height to the width of a bar in the image representation, the bar representing a consecutive sequence of tokens) and identifies a conversational affect of the conversation based on the ratio. For example, a bar with a relatively (i.e. relative to a global average, conversation average, or set threshold, depending on the embodiment) high token number in a short amount of time from a human user is considered indicative of aggression, frustration, or other negative emotion. In one embodiment, when the utterances with high token to time ratio (or low time to token number ratio), the conversation is unlikely to be positive in tone and the conversation identifier 324 may identify the conversation as negative or an “exception.”

Depending on the embodiment, where in the duration of the conversation a negative indicator (e.g. a high token to time ratio or low time to token number ratio) occurs may affect the categorization of the conversation as an “exception.” For example, in one embodiment, presence of such a negative indicator indicates that the conversation is less likely to be positive in tone and is categorized as an “exception.” However, in another embodiment, presence of a negative indicator mid-conversation, which may indicate that the conversation turned negative, and/or a negative indicator at the end of the conversation, which may indicate that the user was so frustrated or upset that the conversation was terminated, determines whether the conversation is categorized as an “exception.” In one embodiment, the conversation identifier 324 may discount the negative affect of a conversation where negative indicators are present at the beginning of a conversation, which may represent anger or frustration of a user at circumstances pre-dating and resulting in the conversation (e.g. the user is annoyed because there has been an error on an account), and does not indicate that the conversation itself is negative or that the other user has aggravated or frustrated that user or was not effectively communicating appropriately.

Identification of conversations using a negative indicator, such as that described herein, in effect provides a machine insight into non-verbal communication. It may also be used to identify problematic conversations, which is useful information for better training human or machine-based agents in the future. For example, identifying conversations between users with a chatbot that did not go, or are not going, well may allow one to identify one or more of the intent of the conversation, whether an agent is underperforming or performing incorrectly, deficiencies in training or tools provided to human or computer agents, and address the shortcoming. For example, when many conversations have a similar intent and the agent is consistently providing the wrong information additional training or re-training may be needed to correct. In another example, in one embodiment, on-going problematic conversations identified based on the image representation (solely or in conjunction with content-based analysis) are identified for intervention. For example, so a human operator may intervene when a customer is becoming frustrated with an automated service (e.g. chatbot) or a supervisor may intervene and engage in an ongoing human-to-human call.

In one embodiment, the conversation identifier 324 identifies one or more features based on a pattern and the image representation of the conversation. The one or more features may include, by way of example and not limitation, one or more of a negative indicator, active listening, pleasantries, information verification, and a user intent.

In one embodiment, the conversation identifier 324 identifies information verification based on one or more patterns and the image representation. For example, referring to FIG. 4 again, the conversation identifier 324 identifies portion 406 as the operator introducing himself/herself, based in part on the bar being at the beginning of the conversation and on the “operator” side of the axis.

In one embodiment, the conversation identifier 324 identifies information verification based on one or more patterns and the image representation. For example, referring to FIG. 4, the conversation identifier 324 identifies portion 408 as the operator verifying information with the customer based on taller operator bars and short customer response, perhaps indicating the customer saying “yes” or “correct.”

In one embodiment, the conversation identifier 324 identifies active listening based on one or more patterns and the image representation. For example, referring to FIG. 4, the conversation identifier 324 identifies portion 410 and the operator's utterances therein as active listening (e.g. the operator saying things like “uh-huh,” “I see,” “okay,” “alright”) while the customer is speaking.

It should be recognized that the foregoing features and patterns are merely examples that may be identified within a conversation based on an image representation and that others exist and are within the scope of the presentation.

Identification of introductions, information verification, and active listening may beneficially allow those portions of the conversation to be filtered out or ignored as noise, to create a higher quality data set for subsequent machine learning (e.g. content-based machine learning) can focus on and learn from the remaining portions of the conversation. For example, the operator's active listening utterances in section 410 need not be analyzed and the user's two utterances (the two bars customer bars above the axis in portion 410) are combined, merged or otherwise analyzed (e.g. later by a content-based machine learning algorithm) as a single utterance, which may allow a machine to more accurately determine a user's intent. It should be recognized that such combination of the utterances (bars as represented in the example illustration) is particularly useful for training machines from human-to-human conversations as humans may interrupt or talk over one another. In one embodiment, a machine may be trained to interject such “active listening” utterances when conversing with a user based on analysis of human-to-human interactions and human usage of such active listening utterances.

In one embodiment, the conversation identifier 324 identifies a negative indicator. A negative indicator is an indicator of negative conversational affect (e.g. fear, anger, frustration, frustration, aggression, etc.). The indicator may vary based on the embodiment. For example, as discussed above, a high token to time ratio or low time to token number ratio may be negative indicators whether determined directly by the conversation image representation generator 322 when generating the image representation or by the conversation identifier 324 by analyzing the image representation (e.g. bar height to width ratio). However, other negative identifiers are contemplated and within the scope of this disclosure.

In one embodiment, the conversation identifier 324 identifies user intent based on the image representation. For example, in one embodiment, the conversation identifier 324 determines from the image representation, or receives as part of the image representation, an average number of tokens per utterance for a user (within the conversation or across conversations, depending on the embodiment) and identifies instances of utterances that satisfy a threshold (e.g. exceed that average number of tokens). In one embodiment, those utterances that exceed that average threshold are identified by the conversation identifier 324, and provided to a human or a machine learning algorithm who identifies the purpose of the conversation and/or intent of the conversation. In other words, in some embodiments, the purpose of a conversation is identified as an utterance that has a number of tokens that exceeds the average number of tokens per utterance. This may allow more rapid classification and training, as it allows a fast and less resource intensive mechanism for identifying a conversation's purpose, or a user's intent.

The conversation mapping engine 326 represents a conversation as a sequence of intents and combines the sequences associated with multiple conversations into a conversation map, and may identify one or more paths in the conversation map, which may be used to train conversational models.

The conversation mapping engine 326 represents a conversation as a sequence of intents. As described above, in one embodiment, the conversation identifier 324 identifies one or more user intents a conversation based on the image representation of the conversation, for example, by identifying user utterances in the conversation that exceed an average number of tokens per utterance in that conversation. A single conversation may include multiple utterances, which the conversation identifier 324 identifies as being associated with a user's intent. The conversation mapping engine 326 identifies these intents and represents an intent as a node and combines the nodes of the conversation with edges. In one embodiment, the edges include directional information, for example, an arrow to convey the order in which the conversation progressed from a first intent pointing to a second intent. In one embodiment, the location of the node may be based on order. For example, a first node on the left may represent an intent (e.g. balance inquiry) that proceeds a second node that represents an intent later in the conversation (e.g. make a payment) positioned to the right of the first node.

The conversation mapping engine 326 combines the representations of multiple conversations into a conversation map. In one embodiment, the conversation map includes a plurality of nodes and edges.

The conversation mapping engine 326 clusters similar intents across multiple conversations. While the identification of intents discussed previously was based on the image representation, and did not necessarily rely on the substance of the conversation or comprehension thereof, generating the clusters of intents, by the conversation mapping engine 326, utilizes the substantive language of the conversations. However, it should be noted identification of these intents within the conversation is more efficient, as the generation and utilization of the image representation of the conversations has significantly reduced the amount of conversations (e.g. removed “on-hold” calls), noise within conversations (e.g. removing holds, information verification, pleasantries), so the analysis may be focused on the utterances (and those around it) identified as being associated with the user's intent.

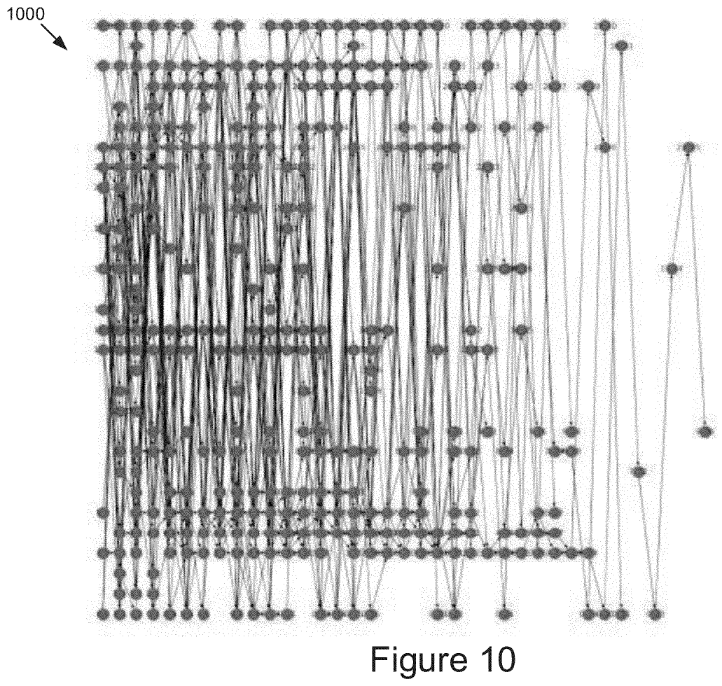

In one embodiment, the conversation mapping engine 326 identifies cluster representing a unique intent from the conversations and represents the cluster as a node in the conversation map. For example, assume all the conversations are between bank customers and its customer service system, the conversation mapping engine 326 may identify a first cluster of user intents associated with “recent transactions,” a second cluster of user intents associated with “current balance,” and third cluster associated with “making a payment,” a fourth cluster associated with “disputing a charge,” a fifth associated with, “reporting a lost or stolen card,” a sixth associated a “balance transfer,” a seventh associated with “speak to a customer service agent,” etc. The conversation mapping engine 326 generates a conversation map including a node for each unique cluster identified. While the preceding example only mentions seven nodes (and seven clusters of intent) there may be many more and the conversation map generated may resemble FIG. 10.

The conversation mapping engine 326 identifies and represents transitions between intents in the conversation map. In one embodiment, a transition from one intent to another during a conversation is represented within the conversation map by an edge between the clusters associated with those intents. For example, a conversation that transitioned from a customer inquiring about recent transactions to disputing a call is represented, in one embodiment, by an edge connecting a first node (associated with the first cluster) to a fourth node (associated with the fourth cluster).

Depending on the embodiment, a frequency of a transition from one intent to another may be represented differently in a conversation map. For example, each instance of a transition from recent transactions to disputing a charge may be represented by its own instance of an edge between the first and fourth node in the conversation map. Alternatively, an edge may be assigned a weight (e.g. an edge representing a more frequent transition, such as recent transactions to dispute charge, may be given a greater weight than a less frequent transition, such as report lost or stolen card to balance transfer.

With the gains in efficiency provided by generating and applying the image representation of conversations, all conversations (e.g. all conversations between bank customers and the bank's customer service number and/or all conversations between customers of the bank and the bank's customer service chat, whether automated, manned by human customer service agents, or both) may be realistically and efficiently processed, and the conversation graph may beneficially represent in a single network—all conversations, topics, and sequences of conversations.

In one embodiment, the conversation mapping engine 326 uses the conversation map to enhance training. In one embodiment, the conversation mapping engine 326 identifies one or more preferred conversational paths. For example, in one embodiment, the conversation mapping engine 326 identifies a the shortest or the densest between nodes to train conversation models.

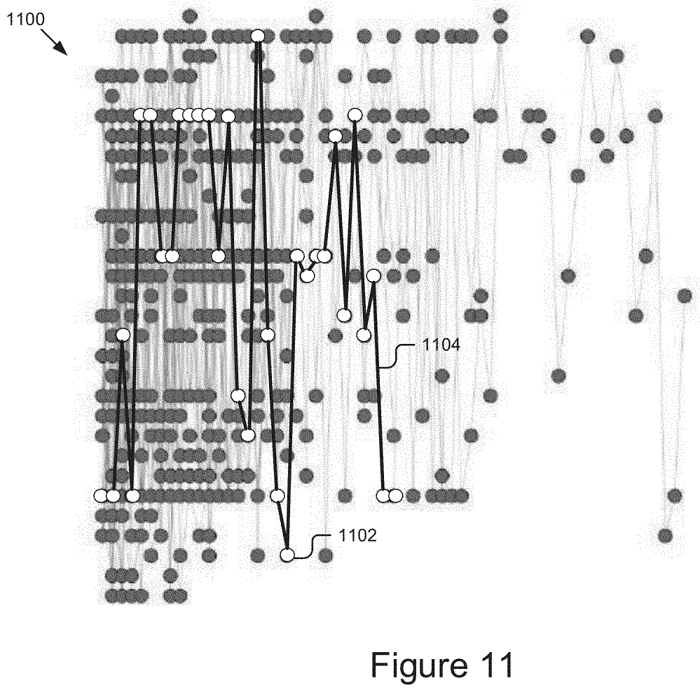

Referring to FIG. 11 another example of a conversation map is illustrated. In the illustrated embodiment, the conversation mapping engine 326 has determined the conversation center (Z(C))* or centroid path for all the conversations of the cluster of the most frequent bridge between all conversation transitions (also occasionally referred to as conversation turns) and represents those as white nodes (e.g. node 1102) connected by a series of edges (e.g. edge 1104) creating a path. This conversation centroid, or center, Z(C) may then be used to train a machine using a semi-supervised approach (e.g. Athena language semi-generation or utterances automatic extraction from elected nodes), and the elected (i.e. white) nodes may be used and integrated into a scenario taught to a machine and the utterances to train the machine.

The full set of conversations mapped to the nodes may be used to train a machine (e.g. a recurrent neural network, such as bi-lstm with attention) to infer user intents.

It should be understood that the node and edge representation discussed above with reference to FIGS. 10 & 11 is merely one example, and other representations are within the scope of this description.

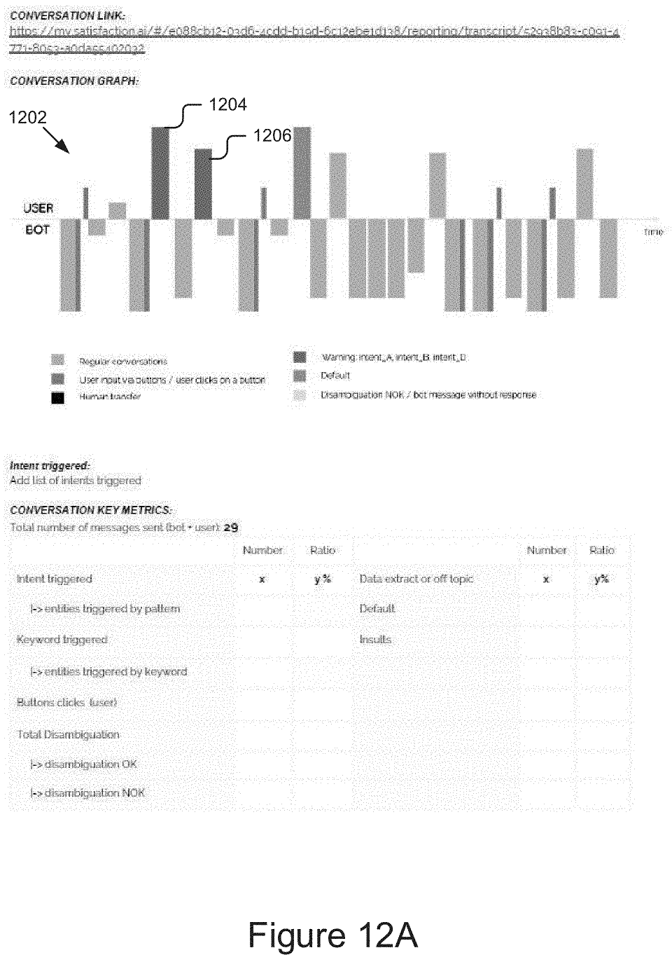

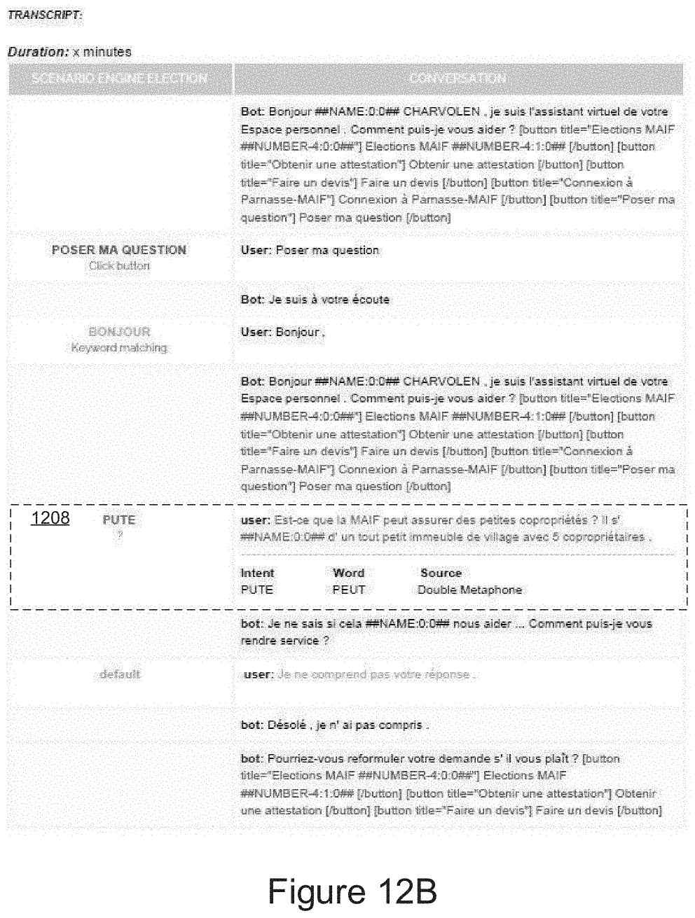

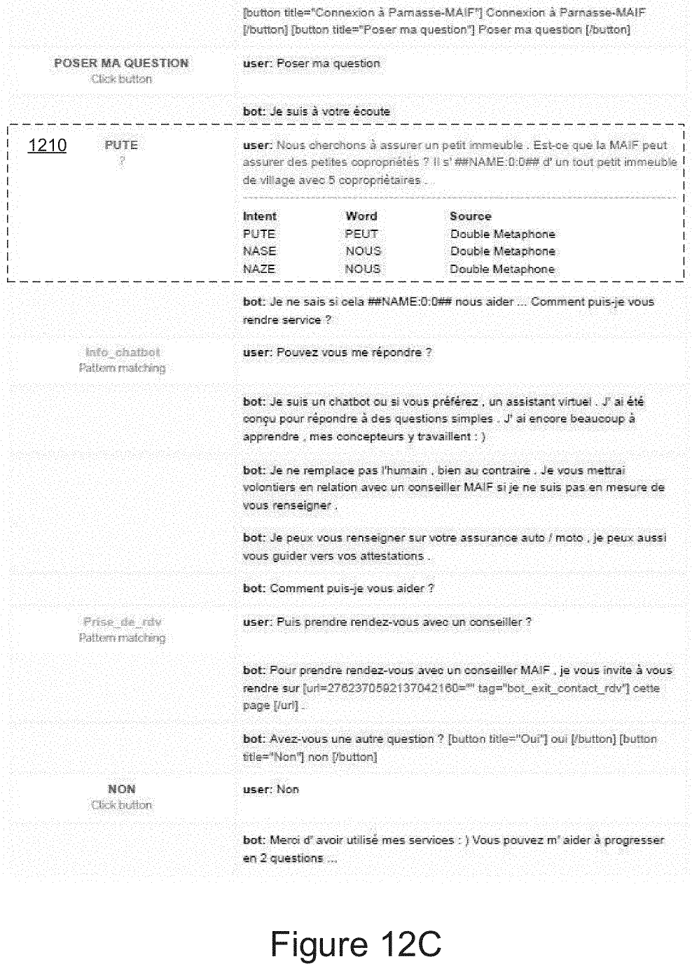

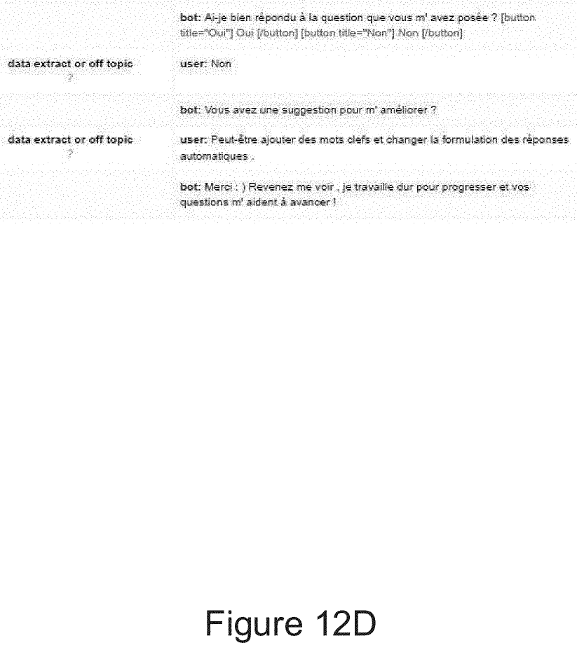

The report generation engine 328 generates one or more reports. The one or more reports may vary based on the embodiment and/or user preference. In one embodiment, the report generation engine 328 generates a report the includes the image representation of a conversation. For example, FIGS. 12A-D each illustrate a page of an example of a report describing a conversation according to one embodiment. FIG. 12A includes an image representation 1202 of the conversation as a bar chart. In the illustrated embodiment, the bars are color coded to provide different information at a glance. For example, bars 1204 and 1206 are color coded red to indicate presence of a potential negative indicator.

FIGS. 12B-D include a transcript of the conversation divided into various parts corresponding to the color-coded portions of the conversation represented in the image representation of the conversation. For example, section 1208 of FIG. 12B and section 1210 of FIG. 12C correspond to bars 1204 and 1206 respectively. This allows an individual reviewing the report to see the potentially problematic portion of the conversation (e.g. where a customer became upset) and examine the reason for it (e.g. was the agent repeating the wrong type of information, is there a double metaphone, is the user's intent being misunderstood, is the agent unable to provide the requested information so that the limitation may be examined and perhaps addressed, etc.)

### Example Benefits and Results

To better understand the benefits of the image representation of the conversation generated by the conversation image representation generator 322 and the use of the image representation by the conversation identifier 324, it may be beneficial to describe some of the above features and functionality in the context of challenges faced in the field of natural language.

The diversity of human language presents challenges to natural language scientists. There are many human languages including English, Spanish, Portuguese, French, Arabic, Hindi, Bengali, Russian, Japanese, Chinese, just to name some of the most widely spoken, and each may include variants (e.g. English spoken in United States vs England vs Australian, French spoken in France vs Quebec vs Algeria, English spoken in New England vs the South within the United states, etc.) This presents challenges to the field of natural language as different languages do not share a common dictionary, and in many cases a common alphabet. However, the image representation of the conversation and subsequent use of the image representation is language-independent in that it does not, itself, rely on understanding the underlying content of the language and substance of conversation. For example, the conversation image representation generator 322 may be used to represent English conversations (where characters are letters from the English alphabet) and Japanese conversations (where characters are kanji characters) with little or no modification.

The non-content-based aspects of human communication present further challenges to natural language scientists. Much of human communication relies on cues not in the words that are written or spoken. It is believed the that 55% of communication is body language, 38% is the tone of voice, and 7% are the actual spoken words. Natural language scientists have focused on that 7% of spoken/written words to understand and infer the intents of the users. However, focusing on such a small portion of human communication is problematic, when trying to create machines that interact with a human and accurately understand and communicate with a human. Use of the image representation and identification of negative identifiers therein allows insight into the atmosphere, or affect, of that conversation based on non-verbal (at least not the substance of the words selected) communication cues. Moreover, those cues are language and culture independent.

Obtaining high-quality (e.g. little noise) data sets on which to perform machine learning is another challenge for natural language scientists. A user's intent and the substance of a conversation is not always straight forward. For example, in a conversation, the substantive aspects of a conversation may be buried among conversational noise including, but not limited to pleasantries, scripted language by one user, on-hold recordings, active listening utterances, information verification, holds, etc. Separation of conversations into various categories and identifying features within conversation based on the image representations may distill the conversation to the most likely portions of the call to be important or substantive and reduce the amount of processing needed to train a machine and, perhaps, achieve a better result by having a better/cleaner training data set by omitting those certain categories and/or portions of a call and focusing on the distilled portions.

It should be realized that the various benefits provided by generating and using the image representation may be found throughout the natural language life cycle including (1) a conversation pipeline and clusterization/classification, (2) pre-processing, (3) post-processing, and (4) runtime.

Regarding conversations pipeline and clusterization, the image representation and the conversation identification based on the image representation, through a Convolutional Neural Network, may efficiently filter many thousands of H2H conversations to a few conversations that are highly relevant to create the knowledge of the agent. Detection of the conversation atmosphere (also referred to as the conversational affect) through the image and extraction of the noisy conversations or the noise from the conversations (like holding parts of the call) to better understand and classify the intent(s) of a dialog or conversation are made possible.

Regarding pre-processing, the image representation and the conversation identification based on the image representation extracts high-value conversation's parts by focusing on dialogue above the average of the dialogue of the conversion, this approach makes it possible to detect interactions with a high density of information very quickly it also extracts the relevant turns in dialogue or conversation to generate a drag and drop interface to help the conceptor of the conversational agent to quickly understand the topics needed.

Regarding post-processing, the image representation and the conversation identification based on the image representation industrializes the quality evaluation of conversations played by the machine to extract statistics based on the conversation types, and generate reports with conversation graphs based on intents or topics detection to retrain the machine or optimize the conversation understanding.

Regarding runtime, the image representation and the conversation identification based on the image representation, a conversational neural network may be trained to classify the conversation in real time to predict the dialogue atmosphere of a conversation, detecting the evolution towards a more aggressive tone on the part of the caller, detect long holding time (e.g. to then reorganize the order of the callers), etc.

### Example Methods

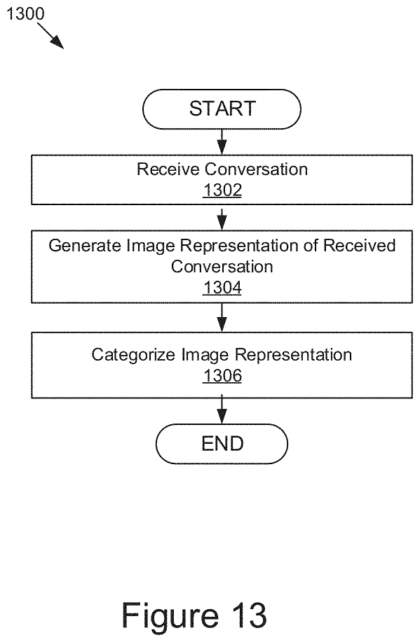

FIGS. 13-15 depict example methods 1300, 1400, 1500 performed by the system described above in reference to FIGS. 1-3 according to some embodiments.

Referring to FIG. 13, an example method 1300 for conversation analysis according to one embodiment is shown. At block 1302, the conversation image representation generator 322 receives a conversation. At block 1304, the conversation image representation generator 322 generates an image representation of the conversation received at block 1302. At block 1306, the conversation identifier 324 identify a categorization of the conversation based on the image representation associated with that conversation, which was generated at block 1304.

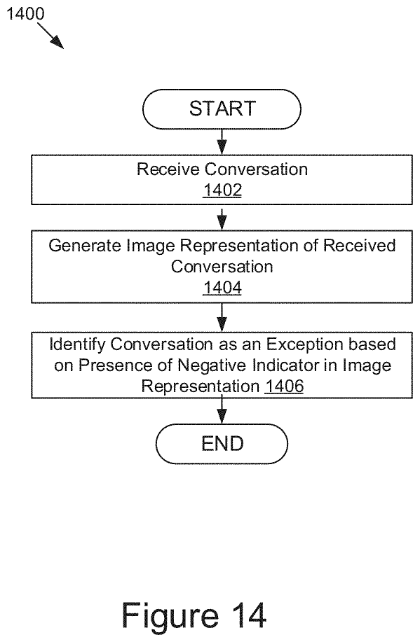

Referring to FIG. 14, an example method 1400 for conversation analysis to identify an exception according to one embodiment is shown. At block 1402, the conversation image representation generator 322 receives a conversation. At block 1404, the conversation image representation generator 322 generates an image representation of the conversation received at block 1402. At block 1406, the conversation identifier 324 categorizes the conversation as an exception based on identifying a negative indicator in the image representation, which was generated at block 1404.

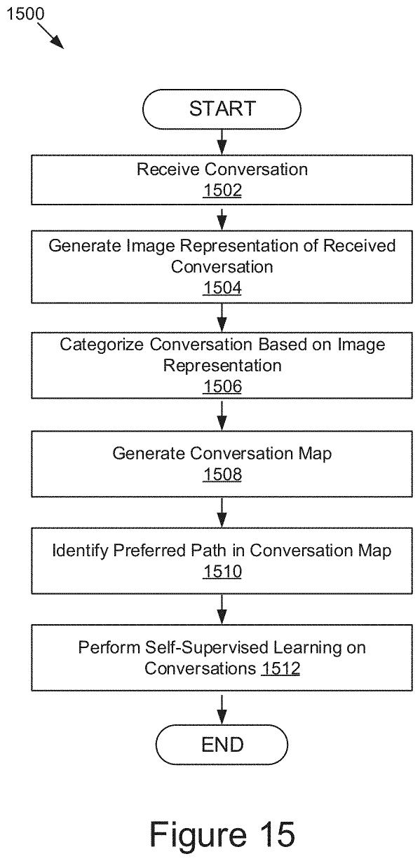

Referring to FIG. 15, an example method 1500 for image representation to self-supervised learning according to one embodiment is shown. At block 1502, the conversation image representation generator 322 receives a conversation. At block 1504, the conversation image representation generator 322 generates an image representation of the conversation received at block 1502. At block 1506, the conversation identifier 324 identifies a categorization of the conversation based on the image representation associated with that conversation, which was generated at block 1504. Blocks 1502-1506 may be repeated for each conversation to be analyzed. At block 1508, the conversation mapping engine 326 generates a conversation map representing the conversations in the set being analyzed. At block 1510, the conversation mapping engine 326 identifies a preferred path in the conversation map. At block 1512, self-supervised learning is performed on the conversation in the set that was analyzed using the preferred path identified at block 1510.

Other Considerations

In the above description, for purposes of explanation, numerous specific details are set forth in order to provide a thorough understanding of the present disclosure. However, it should be understood that the technology described herein can be practiced without these specific details. Further, various systems, devices, and structures are shown in block diagram form in order to avoid obscuring the description. For instance, various implementations are described as having particular hardware, software, and user interfaces. However, the present disclosure applies to any type of computing device that can receive data and commands, and to any peripheral devices providing services.

Reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

In some instances, various implementations may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms including “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Various implementations described herein may relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The technology described herein can take the form of an entirely hardware implementation, an entirely software implementation, or implementations containing both hardware and software elements. For instance, the technology may be implemented in software, which includes but is not limited to firmware, resident software, microcode, etc.

Furthermore, the technology can take the form of a computer program product accessible from a computer-usable or computer-readable medium providing program code for use by or in connection with a computer or any instruction execution system. For the purposes of this description, a computer-usable or computer readable medium can be any non-transitory storage apparatus that can contain, store, communicate, propagate, or transport the program for use by or in connection with the instruction execution system, apparatus, or device.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems, storage devices, remote printers, etc., through intervening private and/or public networks. Wireless (e.g., Wi-Fi™) transceivers, Ethernet adapters, and modems, are just a few examples of network adapters. The private and public networks may have any number of configurations and/or topologies. Data may be transmitted between these devices via the networks using a variety of different communication protocols including, for example, various Internet layer, transport layer, or application layer protocols. For example, data may be transmitted via the networks using transmission control protocol/Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), voice over Internet protocol (VOIP), file transfer protocol (FTP), WebSocket (WS), wireless access protocol (WAP), various messaging protocols (SMS, MMS, XMS, IMAP, SMTP, POP, WebDAV, etc.), or other known protocols.

Finally, the structure, algorithms, and/or interfaces presented herein are not inherently related to any particular computer or other apparatus. Various general-purpose systems may be used with programs in accordance with the teachings herein, or it may prove convenient to construct more specialized apparatus to perform the required method blocks. The required structure for a variety of these systems will appear from the description above. In addition, the specification is not described with reference to any particular programming language. It will be appreciated that a variety of programming languages may be used to implement the teachings of the specification as described herein.

The foregoing description has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As should be understood, the specification may be embodied in other specific forms without departing from the spirit or essential characteristics thereof. Likewise, the particular naming and division of the modules, routines, features, attributes, methodologies and other aspects are not mandatory or significant, and the mechanisms that implement the specification or its features may have different names, divisions and/or formats. Furthermore, the engines, modules, routines, features, attributes, methodologies and other aspects of the disclosure can be implemented as software, hardware, firmware, or any combination of the foregoing. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future. Additionally, the disclosure is in no way limited to implementation in any specific programming language, or for any specific operating system or environment. Accordingly, the disclosure is intended to be illustrative, but not limiting, of the scope of the subject matter set forth in the following claims.

What is claimed is:

1. A method comprising:
receiving, using one or more processors, a first conversation;
identifying, using the one or more processors, a first set of utterances associated with a first conversation participant and a second set of utterances associated with a second conversation participant; and
generating, using the one or more processors, a first image representation of the first conversation, the first image representation of the first conversation visually representing the first set of utterances and second set of utterances, wherein an utterance is visually represented by a first parameter associated with timing of the utterance, a second parameter associated with a number of tokens in the utterance, and a third parameter associated with which conversation participant was a source of the utterance.

2. The method of claim 1, wherein the first image representation of the first conversation is a bar chart, the bar chart including a set of bars, each bar in the set of bars associated with an utterance from one of the first set of utterances and the second set of utterances, a location and first dimension of a first bar along a first axis serving as the first parameter and visually representing a timing of a first utterance represented by the first bar, a second dimension of the first bar along a second axis serving as the second parameter and visually representing a number of consecutive tokens in the first utterance represented by the first bar, and whether the first bar extends in a first direction or second direction from the first axis serving as the third parameter and visually representing whether the first utterance was that of the first conversation participant or the second conversation participant.

3. The method of claim 1 further comprising:
analyzing the first image representation of the first conversation;
identifying, from the first image representation of the first conversation, a hold; and
categorizing the first conversation into a first category based on the identification of the hold.

4. The method of claim 1 further comprising:
analyzing the first image representation of the first conversation;
identifying, from the first image representation of the first conversation, a negative indicator; and
categorizing the first conversation into a first category based on the identification of the negative indicator.

5. The method of claim 4, wherein the negative indicator is based on a ratio between a duration of an utterance and a number of tokens in the utterance, wherein an utterance comprises a sequence of consecutive tokens.

6. The method of claim 4, wherein the first image representation of the first conversation is generated contemporaneously with the first conversation, and subsequent to identifying the negative indicator, the first conversation is identified for intervention.

7. The method of claim 1 further comprising:
analyzing the first image representation of the first conversation; and
filtering one or more of the first conversation and an utterance within the first conversation,
wherein filtering the first conversation includes adding the first conversation to a category based on detecting one or more of a conversational phase and a conversational affect in the first conversation, and
wherein filtering the utterance within the first conversation includes one or more of identifying one or more of a negative indicator, active listening, pleasantries, information verification, and user intent.

8. The method of claim 1 further comprising:
identifying, from the first image representation of the first conversation, one or more intents within the first conversation, wherein an intent is associated with an utterance that satisfies a threshold, the threshold associated with an average number of tokens per utterance.

9. The method of claim 8 further comprising:
receiving the one or more intents identified within the first conversation and one or more intents identified in one or more other conversations;
clustering the one or more intents identified within the first conversation and the one or more intents identified in one or more other conversations to generate a set of clusters associated with unique intents;
generating a conversation map visually representing a first cluster associated with a first unique intent as a first node, a second cluster associated with a second unique intent as a second node, and visually representing a transition between the first unique intent to the second unique intent as edges; and
identifying, from the conversation map, a preferred path; and
performing self-supervised learning based on the preferred path.

10. The method of claim 9, wherein the preferred path is one of a shortest path and a densest path.

11. A system comprising:
one or more processors; and
a memory storing instructions that, when executed by the one or more processors, cause the system to:
receive a first conversation;
identify a first set of utterances associated with a first conversation participant and a second set of utterances associated with a second conversation participant; and
generate a first image representation of the first conversation, the first image representation of the first conversation visually representing the first set of utterances and second set of utterances, wherein an utterance is visually represented by a first parameter associated with timing of the utterance, a second parameter associated with a number of tokens in the utterance, and a third parameter associated with which conversation participant was a source of the utterance.

12. The system of claim 11, wherein the first image representation of the first conversation is a bar chart, the bar chart including a set of bars, each bar in the set of bars associated with an utterance from one of the first set of utterances and the second set of utterances, a location and first dimension of a first bar along a first axis serving as the first parameter and visually representing a timing of a first utterance represented by the first bar, a second dimension of the first bar along a second axis serving as the second parameter and visually representing a number of consecutive tokens in the first utterance represented by the first bar, and whether the first bar extends in a first direction or second direction from the first axis serving as the third parameter and visually representing whether the first utterance was that of the first conversation participant or the second conversation participant.

13. The system of claim 11, wherein the instructions, when executed by the one or more processors, further cause the system to:
analyze the first image representation of the first conversation;
identify, from the first image representation of the first conversation, a hold; and
categorize the first conversation into a first category based on the identification of the hold.

14. The system of claim 11, wherein the instructions, when executed by the one or more processors, further cause the system to:
analyze the first image representation of the first conversation;
identify, from the first image representation of the first conversation, a negative indicator; and
categorize the first conversation into a first category based on the identification of the negative indicator.

15. The system of claim 14, wherein the negative indicator is based on a ratio between a duration of an utterance and a number of tokens in the utterance, wherein an utterance comprises a sequence of consecutive tokens.

16. The system of claim 14, wherein the first image representation of the first conversation is generated contemporaneously with the first conversation, and subsequent to identifying the negative indicator, the first conversation is identified for intervention.

17. The system of claim 11, wherein the instructions, when executed by the one or more processors, further cause the system to:
analyze the first image representation of the first conversation; and
filter one or more of the first conversation and an utterance within the first conversation,
wherein filtering the first conversation includes adding the first conversation to a category based on detecting one or more of a conversational phase and a conversational affect in the first conversation, and
wherein filtering the utterance within the first conversation includes one or more of identifying one or more of a negative indicator, active listening, pleasantries, information verification, and user intent.

18. The system of claim 11, wherein the instructions, when executed by the one or more processors, further cause the system to:
identify, from the first image representation of the first conversation, one or more intents within the first conversation, wherein an intent is associated with an utterance that satisfies a threshold, the threshold associated with an average number of tokens per utterance.

19. The system of claim 18, wherein the instructions, when executed by the one or more processors, further cause the system to:
receive the one or more intents identified within the first conversation and one or more intents identified in one or more other conversations;
cluster the one or more intents identified within the first conversation and the one or more intents identified in one or more other conversations to generate a set of clusters associated with unique intents;
generate a conversation map visually representing a first cluster associated with a first unique intent as a first node, a second cluster associated with a second unique intent as a second node, and visually representing a transition between the first unique intent to the second unique intent as edges; and
identify, from the conversation map, a preferred path; and
perform self-supervised learning based on the preferred path.

20. The system of claim 19, wherein the preferred path is one of a shortest path and a densest path.
